(19) United States
(12) Patent Application Publication
(10) Pub. No.: US 2026/0319844 A1
(43) Pub. Date: Oct. 15, 2026

(54) MEMORY CONSOLIDATION SYSTEM FOR LANGUAGE-MODEL AGENT ENVIRONMENTS

(71) Applicant: MAI LABS LLC, North Bay Village, FL (US)

(72) Inventor: Christopher P. Maiorana, North Bay Village, FL (US)

(21) Appl. No.: 19/706,167

(22) Filed: Jun. 12, 2026

Related U.S. Application Data
(63) Continuation-in-part of application No. 19/639,076, filed on Apr. 3, 2026.
(63) Continuation-in-part of application No. 19/662,132, filed on Apr. 29, 2026.
(60) Provisional application No. 63/906,669, filed on Oct. 28, 2025.
(60) Provisional application No. 63/907,345, filed on Oct. 29, 2025.
(60) Provisional application No. 63/910,206, filed on Nov. 3, 2025.
(60) Provisional application No. 63/911,540, filed on Nov. 5, 2025.
(60) Provisional application No. 63/912,463, filed on Nov. 6, 2025.
(60) Provisional application No. 63/914,590, filed on Nov. 10, 2025.
(60) Provisional application No. 63/920,698, filed on Nov. 19, 2025.
(60) Provisional application No. 63/929,125, filed on Dec. 2, 2025.
(60) Provisional application No. 63/939,903, filed on Dec. 12, 2025.
(60) Provisional application No. 63/972,622, filed on Jan. 30, 2026.
(60) Provisional application No. 63/974,179, filed on Feb. 2, 2026.
(60) Provisional application No. 63/983,780, filed on Feb. 16, 2026.
(60) Provisional application No. 64/005,696, filed on Mar. 14, 2026.
(60) Provisional application No. 64/020,279, filed on Mar. 28, 2026.
(60) Provisional application No. 64/026,578, filed on Apr. 2, 2026.
(60) Provisional application No. 64/041,178, filed on Apr. 16, 2026.
(60) Provisional application No. 64/043,412, filed on Apr. 18, 2026.
(60) Provisional application No. 64/049,578, filed on Apr. 25, 2026.
(60) Provisional application No. 64/056,034, filed on May 3, 2026.
(60) Provisional application No. 64/059,120, filed on May 6, 2026.
(60) Provisional application No. 64/062,752, filed on May 11, 2026.
(60) Provisional application No. 64/070,260, filed on May 20, 2026.
(60) Provisional application No. 64/076,365, filed on May 28, 2026.

(51) Int. Cl. G06F 9/50

(52) U.S. Cl. CPC G06F 9/5016

(57) ABSTRACT

A computer-implemented system for memory consolidation in a language-model agent environment, comprising a scheduled processing module, a pattern-extraction module, a curation module and a review-gate controller. The scheduled processing module may be configured to operate on a persistent memory store and accumulated session data from one or more prior agent sessions. The pattern-extraction module may be configured to identify recurring patterns across the accumulated session data based on the persistent memory store. The curation module may be configured to transform the identified recurring patterns into content for an independent memory store. The review-gate controller may be configured to generate the independent memory store according to one of an automatic mode of operation and a review mode of operation. The independent memory store may be applied as one source for an input to influence behavior of subsequent agent sessions according to the review-gate controller.

This application relates to U.S. Provisional Application No. 63/906,669, filed on Oct. 28, 2025. This application also relates to U.S. Provisional Application No. 63/907,345, filed on Oct. 29, 2025. This application also relates to U.S. Provisional Application No. 63/910,206, filed on Nov. 3, 2025. This application also relates to U.S. Provisional Application No. 63/911,540, filed on Nov. 5, 2025. This application also relates to U.S. Provisional Application No. 63/912,463, filed on Nov. 6, 2025. This application also relates to U.S. Provisional Application No. 63/914,590, filed on Nov. 10, 2025. This application also relates to U.S. Provisional Application No. 63/920,698, filed on Nov. 19, 2025. This application also relates to U.S. Provisional Application No. 63/929,125, filed on Dec. 2, 2025. This application also relates to U.S. Provisional Application No. 63/939,903, filed on Dec. 12, 2025. This application also relates to U.S. Provisional Application No. 63/972,622, filed on Jan. 30, 2026. This application also relates to U.S. Provisional Application No. 63/974,179, filed on Feb. 2, 2026. This application also relates to U.S. Provisional Application No. 63/983,780, filed on Feb. 16, 2026. This application also relates to U.S. Provisional Application No. 64/005,696, filed on Mar. 14, 2026. This application also relates to U.S. Provisional Application No. 64/020,279, filed on Mar. 28, 2026. This application also relates to U.S. Provisional Application No. 64/026,578, filed on Apr. 2, 2026. This application also relates to U.S. patent application Ser. No. 19/639,076, filed on Apr. 3, 2026. This application also relates to U.S. Provisional Application No. 64/041,178, filed on Apr. 16, 2026. This application also relates to U.S. Provisional Application No. 64/043,412, filed on Apr. 18, 2026. This application also relates to U.S. Provisional Application No. 64/049,578, filed on Apr. 25, 2026. This application also relates to U.S. patent application Ser. No. 19/662,132, filed on Apr. 29, 2026. This application also relates to U.S. Provisional Application No. 64/056,034, filed on May 3, 2026. This application also relates to U.S. Provisional Application No. 64/059,120, filed on May 6, 2026. This application also relates to U.S. Provisional Application No. 64/062,752, filed on May 11, 2026. This application also relates to U.S. Provisional Application No. 64/070,260, filed on May 20, 2026. This application also relates to U.S. Provisional Application No. 64/076,365, filed on May 26, 2026. Each mentioned application is hereby incorporated by reference in its entirety.

### FIELD OF THE INVENTION

The invention relates to generative content from large language models generally and, more particularly, to a method and/or apparatus for implementing a memory consolidation system for language-model agent environments. The present invention further concerns scheduled between-session processing of accumulated agent session data and existing memory stores to produce curated, reviewable independent memory stores that may be used to influence subsequent agent behavior at an inference-pipeline layer without modification of underlying language-model weights.

The invention further relates to cross-agent pattern aggregation, in which session data from a plurality of distinct agent instances is processed collectively to identify patterns that are not detectable within session data from any single agent. The patterns may be consolidated into team-wide and domain-wide memory stores.

The invention further relates to applying review-gated curated memory stores to an existing memory store. Proposed updates are presented to a user node for receiving feedback to accept, reject, or modify commands prior to application. The rejected updates and the rationale for rejection are recorded and fed back to refine subsequent update generation.

The invention further relates to structural positioning of tokens derived from curated memory stores within token sequences provided for inference operations of language-model agent environments, including high-ranking attention position placement, dual-vocabulary tokenization paths, pre-embedding positioning, and assembly-module substitution.

### BACKGROUND

Use of generative artificial intelligence (AI) is becoming increasingly popular. AI technology is developing rapidly. Results generated by AI models can be improved through training data, and the various weights and biases internal to the AI model. Training, updating and deploying AI technology is expensive and resource intensive. Another option for improving results generated by AI models is through providing adjustments to the input provided to and/or output generated by AI models without modifications to the underlying AI model.

Conventional language-model agent platforms operate either as stateless systems or shallow-stateful systems. Stateless systems lose all knowledge between sessions. Shallow-stateful systems can retain knowledge only through context-window assembly. Both approaches fail to scale to long-running enterprise deployments where agents accumulate substantial interaction history. Stateless systems require human re-explanation of context at each session boundary. Shallow-stateful systems hit context-window limits as accumulated history grows, and the assembled context exerts only probabilistic influence on the behavior of the agent in any given session.

It would be desirable to implement a memory consolidation system for language-model agent environments.

### SUMMARY

The invention concerns a computer-implemented system for memory consolidation in a language-model agent environment, comprising a scheduled processing module, a pattern-extraction module, a curation module and a review-gate controller. The scheduled processing module may be configured to operate on a persistent memory store and accumulated session data from one or more prior agent sessions. The pattern-extraction module may be configured to identify recurring patterns across the accumulated session data based on the persistent memory store. The curation module may be configured to transform the identified recurring patterns into content for an independent memory store. The review-gate controller may be configured to generate the independent memory store according to one of an automatic mode of operation and a review mode of operation. The automatic mode of operation may be configured to apply the independent memory store without an intervening action from a user. The review mode of operation may be configured to present the independent memory store to the user to enable the user to provide feedback for the content in the independent memory store prior to applying the independent memory store. The independent memory store may be applied as one source for an input to influence behavior of subsequent agent sessions according to the review-gate controller.

### BRIEF DESCRIPTION OF THE FIGURES

Embodiments of the invention will be apparent from the following detailed description and the appended claims and drawings.

FIG. 1 is a block diagram illustrating an example embodiment of the present invention.

FIG. 2 is a block diagram illustrating an architectural separation of a training layer and a memory consolidation system implemented in an inference-pipeline layer.

FIG. 3 is a block diagram illustrating a memory consolidation system.

FIG. 4 is a block diagram illustrating forward binding substitution.

FIG. 5 is a flow diagram illustrating a method for implementing memory consolidation for a language-model agent environment.

FIG. 6 is a flow diagram illustrating a method for memory consolidation with forward binding.

### DETAILED DESCRIPTION OF THE EMBODIMENTS

Embodiments of the present invention include providing a memory consolidation system for language-model agent environments that may (i) be distinct from a training layer for a large language model, (ii) provide a distinct memory store from a persistent memory store used by a transformer, (iii) curate recognized patterns from previous interactions with an artificial intelligence agent into feedback for subsequent interactions, (iv) automatically apply the recognized patterns into an independent memory store, (v) present an independent memory store to an end-user for manual review before application, (vi) enable a curated, independent memory store to be selected as one input for a subsequent conversational turn with a large language model, (vii) tokenize the consolidated memory content for forward binding substitution and/or (viii) be implemented as one or more integrated circuits.

Embodiments of the present invention may be configured to implement a memory consolidation system. The memory consolidation system may be configured to operate alongside a transformer network (e.g., an artificial intelligence (AI) model, a large language model (LLM), etc.). The memory consolidation system may be configured to operate independently from the training of and/or adjustments to the weights and/or biases internal to the transformer. The memory consolidation system may be configured to operate as an automated scheduled background operation that may analyze information in a persistent memory store and/or accumulated session data for recurring patterns. The recurring patterns may be identified and/or curated into an independent memory store. The independent memory store may be provided as an input to subsequent agent sessions, alongside and/or in place of, the persistent memory store. In some embodiments, the independent memory store generated may be applied as input without user interaction. In some embodiments, the independent memory store generated may be provided as feedback to the end-user for review, approval, rejection and/or modification. Support for the memory-consolidation architectures described herein may be found in U.S. Provisional Application No. 63/911,540, filed on Nov. 5, 2025, U.S. Provisional Application No. 63/912,463, filed on Nov. 6, 2025, and/or U.S. Provisional Application No. 63/914,590, filed on Nov. 10, 2025, appropriate portions of which are incorporated by reference.

Training-layer interventions, such as fine-tuning, weight updates, and/or model retraining occupy a different architectural space from the memory consolidation system in agent environments. For example, training-layer systems address the problem of teaching a language model new capabilities, new domain knowledge, new behavioral characteristics, etc. that should be uniformly present in the responses of the model across all subsequent uses. Training-layer interventions may be supported by an established body of art.

The memory consolidation system in agent environments may address a different problem than training-layer interventions. Agent sessions may accumulate session-specific, deployment-specific, and/or team-specific patterns that may influence and/or govern subsequent agent behavior within a particular deployment context, but do not affect model behavior across all uses. The behavioral adjustments enabled by the memory consolidation system may be selectively reversible, reviewable before deployment, and/or auditable in terms of the specific session data that justified the particular behavior adjustment.

The memory consolidation system may operate in the memory-consolidation architectural space. Embodiments of the present invention do not propose a substitution of inference-pipeline operation for training-layer operation. Embodiments of the present invention do not propose inference-pipeline operation as an alternative implementation of training-layer goals. The memory consolidation system may provide architectural commitments that memory consolidation requires (e.g., selective reversibility at the memory store granularity, gating that enables review before deployment, end-to-end provenance from agent behavior back to source session data, and inference-pipeline-layer operation that may preserve all of the foregoing). For example, training-layer systems are not designed to provide the functionality of the memory consolidation system and are not the relevant comparison.

In some embodiments, the memory consolidation system may be configured to manage authoritative-source content. A tokenization layer may be implemented to prohibit an inference operation of a transformer network from generating output corresponding to the authoritative-source content other than through tokens derived from the independent memory store. For example, the memory consolidation may provide mandatory authoritative grounding (e.g., when an authoritative source exists for a value required in the output of an agent, the inference operation has no permission to invent the value). The output must flow through the curated authoritative-source channel. Support for authoritative source management may be described in association with U.S. patent application Ser. No. 19/639,076, filed on Apr. 3, 2026, and U.S. patent application Ser. No. 19/662,132, filed on Apr. 29, 2026, appropriate portions of which are incorporated by reference.

In some embodiments, the memory consolidation system may be configured to implement forward binding. The forward binding may be configured to annotate each independent memory store with one or more bounded semantic properties. A tokenization layer may be implemented. The tokenization layer may be configured to replace the independent memory store in a token sequence with an opaque handle bearing the bounded semantic properties. The opaque handle may be configured to prevent an inference operation from accessing an underlying authoritative value while permitting derivational reasoning over the bounded semantic properties. Support for forward binding may be described in association with U.S. Provisional Application No. 64/049,578, filed on Apr. 25, 2026, appropriate portions of which are incorporated by reference.

Embodiments of the memory consolidation system that implement forward binding may address both expressive drift (e.g., where the AI model generates output inconsistent with authoritative source content) and/or derivational drift (e.g., where the AI model performs intermediate reasoning over the authoritative source content and produces conclusions inconsistent with the source). By withholding underlying values from the inference operation while exposing only bounded semantic properties, the forward binding module may prevent both classes of drift at the architectural level.

Embodiments of the present invention may be configured to perform scheduled memory consolidation to convert unbounded session accumulation into the independent memory store. The scheduled consolidation between sessions may transform the unbounded growth of raw session logs into a curated, finite, reusable structured update data set that may be formatted as the independent memory store. The size of the independent memory store may become bounded by the persistence threshold and the curation rules rather than by the rate of session generation. Long-running agent deployments may remain operationally viable at scales where raw session retention would have exhausted storage and context-window resources.

Embodiments of the present invention may enable cross-agent patterns to be surfaced that may be invisible to any single agent. Cross-agent aggregation performed by the memory consolidation surfaces patterns at the team and deployment scale that no single agent could identify from the individual session data of the single agent. For example, recurring mistakes affecting multiple agents may be detected and corrected at the team level rather than re-occurring per-agent. Convergent workflows arrived at independently by multiple agents may be consolidated into shared team practice rather than each agent re-discovering the workflow. Shared preferences may propagate across deployment groups without manual configuration.

The memory consolidation system may provide a reviewable, reversible, auditable adaptation without affecting the training infrastructure. Embodiments of the present invention may implement inference-pipeline-layer operation. The operations performed at the inference-pipeline-layer may enable behavioral adaptation without access and/or adjustments to training infrastructure and/or compute. Each adaptation generated may be a structured data set that forms an independent memory store. The data in the independent memory store may be reviewed before deployment, applied selectively, removed if undesirable, and/or audited for the session data that justified the generation of the independent memory store. The adaptation may be reversible at the memory store and/or data set level rather than only through AI model redeployment. For example, the audit trail may be explicit and inspectable rather than encoded across distributed weights.

The memory consolidation system may provide human governance of curation deployment. In one example, a review-gate architecture may be implemented. The review-gate architecture may preserve human control over which curated patterns may be deployed into agent behavior. For example, the memory consolidation system may propose data for the independent memory store and the end user (e.g., a human) may determine how the data is disposed of. Proposals may be accompanied by contextual analytics that make the deployment decision informed rather than blind. Rejections of proposals may be recorded with rationale, and the curation module may learn from rejections to refine future proposals.

The memory consolidation system may be configured to provide end-to-end provenance and/or audit traceability. In some embodiments, every agent behavior influenced by the independent memory store may be traced back through a provenance token of the pattern used for the independent memory store to the session data from which the pattern was derived. Every application event of data into the memory store may be recorded. Every review-gate operation may be recorded. Compliance, regulatory, and/or debugging requirements that depend on understanding why an agent behaved a particular way may be satisfied at the architectural level.

Embodiments of the present invention may be configured to provide structural influence of agent output where token-positioning embodiments are employed. In embodiments employing the token sequencer module, the independent memory store may be positioned at high-ranking attention token positions in the inference operation rather than inserted into the context window as conventional prompt content. The independent memory store may influence agent output structurally rather than competing for attention probabilistically with the rest of the context. Behavioral consistency between sessions may become a property guaranteed by the architecture rather than achieved by hoping the right context fragments were retrieved.

The forward-binding implemented in some embodiments of the present invention may reduce expressive and/or derivational drift. The inference operation has no access to the underlying authoritative value during reasoning. Drift of any kind (e.g., expressive drift in the output and derivational drift in intermediate reasoning steps) may be prevented at the architectural level because the value the model would drift from is not visible to the AI model. For example, reasoning may operate over bounded semantic properties exposed via opaque handles.

Embodiments of the present invention may provide mandatory authoritative grounding in authoritative-source data. In authoritative-source embodiments, the inference operation cannot generate output corresponding to authoritative-source content through inference. For example, the output must flow through the curated artifact channel. The architectural commitment prohibits hallucination of authoritative values at the source rather than detecting and correcting hallucination after generation.

Embodiments of the present invention may provide memory consolidation in commercial language-model agent platforms. In one example, the memory consolidation system may be implemented in multi-agent enterprise deployments. In another example, the memory consolidation system may be implemented in long-running autonomous workflows. In yet another example, the memory consolidation system may be implemented in regulated-industry agent applications (e.g., use cases such as medical, legal, financial, government, etc.). In still another example, the memory consolidation system may be implemented in cross-team learning in agent ecosystems. In yet another example, the memory consolidation system may be implemented in compliance and audit applications. In still another example, the memory consolidation system may be integrated with existing language-model agent platforms. The particular industrial applicability of the memory consolidation system may be varied according to the design criteria of a particular implementation.

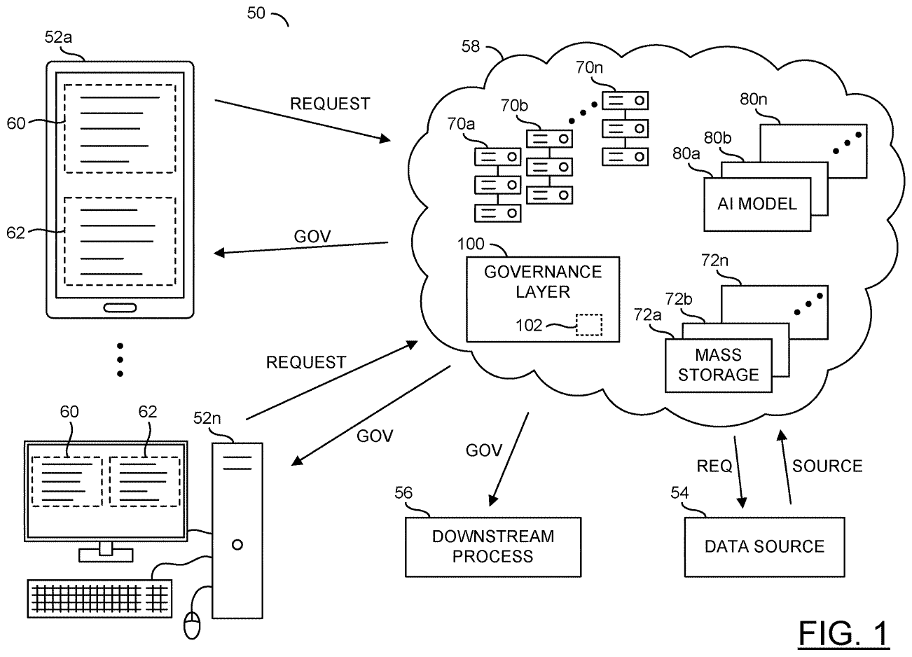

Referring to FIG. 1, a block diagram illustrating an example embodiment of the present invention is shown. A system 50 is shown. The system 50 may be an example cloud communication network. The cloud communication network 50 may enable interconnected devices to communicate with remote resources.

The cloud communication network 50 may comprise a number of blocks (or circuits) 52a-52n, a block (or circuit) 54 and/or a block (or circuit) 56 each in communication with a cloud computing service 58. The circuits 52a-52n may each implement a user device. The circuit 54 may be a data source (e.g., an authoritative data source). The circuit 56 may be a downstream process. The cloud communication network 50 may comprise other components (e.g., local networks, wide area networks, communication hardware such as routers, modems, last mile infrastructure, etc.). In the example shown, each of the user device 52 may be displaying content 60-62. The particular components of the cloud communication network 50 may be varied according to the design criteria of a particular implementation.

The cloud communication network 50 may comprise a number of blocks (or circuits) 70a-70n, a number of blocks (or circuits) 72a-72n, a number of blocks (or circuits) 80a-80n and/or a block (or circuit) 100. The circuits 70a-70n may implement server computers. The circuits 72a-72n may comprise mass storage devices. The circuits 80a-80n may comprise AI models and/or AI engines. The circuit 100 may implement an apparatus and/or a system (e.g., a governance layer, content pre-filtering system, an output governance layer, etc.). The cloud communication network 50 may comprise other components (not shown). The number, type and/or arrangement of the components of the cloud communication network 50 may be varied according to the design criteria of a particular implementation.

The cloud computing service 58 may be configured to store data, retrieve and transmit stored data, process data and/or communicate with other devices. The server computers 70a-70n and/or the mass storage devices 72a-72n may be implemented as part of a cloud computing platform (e.g., distributed computing). In an example, the server computers 70a-70n and/or the mass storage devices 72a-72n may be implemented as a group of cloud-based, scalable server computers. By implementing a number of scalable servers, additional resources (e.g., power, processing capability, memory, etc.) may be available to process and/or store variable amounts of data. For example, the cloud computing service 58 may be configured to scale (e.g., provision resources) of the server computers 70a-70n and/or the mass storage devices 72a-72n based on demand. The cloud computing service 58 may implement scalable computing (e.g., cloud computing). The scalable computing may be available as a service to allow access to processing and/or storage resources without having to build infrastructure (e.g., the provider of the apparatus 100, the client devices 52a-52n and/or the AI engines 80a-80n do not have to build the infrastructure of the cloud computing service 58).

Each of the server computers 70a-70n may comprise memory and/or processors. Each of the mass storage devices 72a-72n may comprise storage devices (e.g., hard drives, solid state drives, etc.). The cloud computing service 58 may aggregate the resources provided by the server computers 70a-70n and/or the mass storage devices 72a-72n to provision resources based on demand. For example, cloud computing (e.g., processing) may be made available by provisioning the processing capabilities of the server computers 70a-70n. In another example, the storage capacity of the mass storage devices 72a-72n may enable the cloud computing service 58 to provide cloud storage services. The particular services available and/or the provision of the services of the cloud computing service 58 may be varied according to the design criteria of a particular implementation.

The cloud processing provided by the cloud computing service 58 may provide resources for implementing the AI engines 80a-80n. The AI engines 80a-80n may implement one or more machine learning models trained to generate natural language and/or structured reasoning outputs. For example, the machine learning models may comprise large language models (LLMs), transformer-based neural networks, vision-language models (VLMs), and/or other generative inference systems that may be capable of producing contextual responses based on input prompts and/or retrieved information. Generally, the AI engines 80a-80n may be configured to generate probabilistically inferred content. The particular types of models implemented by the AI engines 80a-80n may be varied according to the design criteria of a particular implementation.

The apparatus 100 may be implemented by the cloud computing service 58. In the example shown, the apparatus 100 may be shown as a separate component from the server computers 70a-70n, the mass storage devices 72a-72n and/or the AI engines 80a-80n for illustrative purposes. In some embodiments, the apparatus 100 may be integrated as part of one or more of the components of the cloud computing service 58. In one example, the apparatus 100 may comprise computer readable instructions that may be executable by the server computers 70a-70n in conjunction with the AI models 80a-80n. The operations and/or features provided by the apparatus 100 may be performed by the various resources provisioned by the cloud computing services 58. For example, the apparatus 100 may be implemented using various instruction sets (e.g., x86, x86-64, ARM, RISC-V, etc.) implemented by the processing devices (e.g., CPU, GPU, APU, NPU, etc.) of the server computers 70a-70n. The particular interactions of the apparatus 100 with the other components of the cloud computing service 58 may be varied according to the design criteria of a particular implementation.

The client devices 52a-52n may each be a computing device used by an end user. The client devices 52a-52n may be configured to receive input from the end user, communicate with external networks, store data, execute computer readable instructions, etc. For example, one or more of the client devices 52a-52n may comprise a smartphone, a tablet computing device, a desktop computer, a smartwatch, a laptop computer, a netbook computer, smart glasses, a vehicle infotainment system, etc. Generally, the client devices 52a-52n may comprise an output display, input peripherals (e.g., a keyboard, a touchscreen, a microphone, a mouse, a gamepad, etc.), a processor, a memory, etc. For example, the combination of the processor and the memory implemented by the client devices 52a-52n may enable the client devices 52a-52n to execute computer readable instructions (e.g., implement an operating system, execute programs/apps, receive/process input and generate output, etc.). The client devices 52a-52n may be configured to execute an operating system (e.g., Windows, MacOS, IOS, Linux, Android, Fuchsia, etc.). The client devices 52a-52n may be configured to implement processing devices such as a CPU, an APU, an NPU (e.g., an AI-accelerated processor) that may implement various instruction sets (e.g., x86, x86-64, ARM, RISC-V, etc.). In the example shown, the client device 52a may be a smartphone and the client device 52n may be a desktop computer. The type and/or implementation of the client devices 52a-52n may be varied according to the design criteria of a particular implementation.

The end user may generally be a person operating one or more of the client devices 52a-52n. In some embodiments, the end user may be a system (e.g., an automated system). In one example, an automated system may be programmed to make requests to the apparatus 100. In another example, the end user may be an AI controlled device. Whether the client devices 52a-52n are controlled directly by a person and/or an automated system may be varied according to the design criteria of a particular implementation.

The client devices 52a-52n are shown displaying content 60-62. In the example shown, the content 60-62 may be visually represented as content displayed on a screen. The content 60 may be an input. The content 62 may be an output. For example, the end user may provide the input content 60 to one of the client devices 52a-52n and the client devices 52a-52n may provide the output content 62 to the end user. In one example, the content 60-62 may comprise a conversational turn. The type of the content 60-62 may be varied according to the design criteria of a particular implementation.

The client devices 52a-52n are each shown generating a signal (e.g., REQUEST). The signal REQUEST may be communicated by the client devices 52a-52n to the cloud computing service 58. The signal REQUEST may comprise the input content 60 from the client devices 52a-52n. For example, the end user may provide the input content 60 to one or more of the client devices 52a-52n and the client devices 52a-52n may communicate the input content 60 to the cloud computing service 58. In the example of the cloud communication network 50 with the apparatus 100 and the AI engines 80a-80n, the signal REQUEST may comprise a query provided to the AI engines 80a-80n. For example, the end user may ask a natural language question as the input content 60 and the natural language question may be forwarded to the AI engines 80a-80n of the cloud computing service 58 to provide the answer.

The client devices 52a-52n are each shown receiving a signal (e.g., GOV). The signal GOV may be communicated by the cloud computing service 58 to the client devices 52a-52n. The signal GOV may comprise the output content 62 for the client devices 52a-52n. For example, the cloud computing service 58 may provide the output content 62 to one or more of the client devices 52a-52n and the client devices 52a-52n may display the output content 62 to the end user. In the example of the cloud communication network 50 with the apparatus 100 and the AI engines 80a-80n, the signal GOV may comprise a response to the query (e.g., a response to the signal REQUEST) generated by the AI engines 80a-80n. For example, the AI engines 80a-80n may provide the answer to the natural language question, which may be displayed by the client devices 52a-52n as the output content 62.

The data source 54 and/or the downstream process 56 may be configured to interact with the cloud computing service 58. For example, when providing the answer to the query received from the client devices 52a-52n, the apparatus 100 and/or the AI engines 80a-80n may further communicate with the data source 54 and/or the downstream process 56.

The data source 54 may be an authoritative data source. The authoritative data source 54 may be configured to receive a signal (e.g., REQ) and provide a signal (e.g., SOURCE). The signal SOURCE may be an input that may be used by the AI engines 80a-80n to provide the output GOV of the client devices 52a-52n and/or the downstream process 56.

The authoritative data source 54 may be configured to provide authoritative data. The signal SOURCE may comprise the authoritative data. The authoritative data may be distinct from probabilistically inferred data generated by the AI engines 80a-80n. The apparatus 100 may be configured to ensure that the authoritative data from the authoritative data source 54 is provided in response to the input provided by the client devices 52a-52n. For example, the authoritative data source 54 may provide ground truth data and/or data that may have deterministic authority.

The downstream process 56 may be a process and/or device that may use and/or rely on the output content 62. For example, the client devices 52a-52n may provide the input content 60 (e.g., the signal REQUEST), which may be used to provide the output content 62 (e.g., the signal GOV) that may be usable by the downstream process 56. The downstream process 56 may be configured to receive the signal GOV. Generally, the downstream process 56 may be agnostic to how the output content 62 of the signal GOV has been generated. For example, the downstream process 56 may be configured to use the data provided in the signal GOV without prior knowledge of how the data was acquired, whether the data is accurate, whether the data is reliable, etc. In one example, the downstream process 56 may be configured to communicate the output GOV back to the client devices 52a-52n. In another example, the downstream process 56 may save the output content 62 as a file on a computing device. In yet another example, the downstream process 56 may be an agentic response to the output content 62. In still another example, the downstream process 56 may comprise sending a prescription, approving a financial transaction, executing a treatment plan, filing a legal document, etc. The number and/or types of the downstream process 56 may be varied according to the design criteria of a particular implementation.

The apparatus 100 may be configured to control, filter, govern, influence, etc. the data provided in the signal GOV. For example, without the apparatus 100, the output content 62 in the signal GOV may comprise inaccurate data, hallucinated data, near-hallucinated data, data resulting from AI model drift, unreliable data, etc. In some embodiments, the apparatus 100 may be configured to consolidate data accumulated over time based on the content 60-62. In some embodiments, the apparatus 100 may be configured to bind the output of the AI engines 80a-80n to authoritative data retrieved from the authoritative data source 54. Generally, the apparatus 100 may operate transparently to the client devices 52a-52n and/or the downstream process 56. For example, any instructions and/or apps executed by the client devices 52a-52n and/or the downstream process 56 may not necessarily benefit from modification for compatibility with the apparatus 100 (e.g., the compatibility of the apparatus 100 may be inherent based on the architecture of the apparatus 100 and/or how the apparatus 100 interacts with the input/output of the AI engines 80a-80n).

The apparatus 100 may be implemented as part of a content generation system along with the AI engines 80a-80n. The apparatus 100 may be configured to pre-format input to the AI engines 80a-80n and/or filter output generated by the AI engine 80a-80n. For example, the apparatus 100 may modify and/or guide data to/from the AI engines 80a-80n without directly affecting the model implemented by the AI engines 80a-80n and/or operation of the AI engines 80a-80n.

The apparatus 100 may operate on semantic units derived from generated content and/or may directly analyze the internal token representations produced by the AI engines 80a-80n. Tokens generated by a language model may generally correspond to fragments of text used during probabilistic sequence generation and do not necessarily correspond to complete informational assertions. By contrast, the semantic units may represent higher-level informational elements extracted from the authoritative data source 54 that may correspond to discrete factual statements, parameter values, inferential assertions, etc. By operating at the semantic-unit level, the apparatus 100 may evaluate the meaning and/or authority of individual assertions, which may enable validation, filtering, and/or modification of specific informational elements without requiring access to the internal token-generation mechanisms of the underlying model of the AI engines 80a-80n. The semantic units may enable the apparatus 100 to function with a wide variety of generative models while maintaining consistent control over the informational content of the final output.

In some embodiments, the apparatus 100 may convert the ungoverned output generated by the AI engine 80a-80n into semantic units and/or operate at a token level. The apparatus 100 may enable downstream analysis modules (e.g., the downstream process 56) to evaluate and/or operate on individual informational assertions rather than treating the ungoverned generated output as a monolithic block of text. For example, the apparatus 100 may modify, annotate, filter, and/or replace specific semantic units when validation rules, inference distance thresholds, and/or epistemic classification policies indicate that the ungoverned generated content should be altered prior to final output generation.

### Memory Consolidation Architectures

The apparatus 100 may comprise a block (or circuit) 102. The circuit 102 may implement a memory consolidation system. The apparatus 100 may comprise other components (not shown). Generally, the memory consolidation system 102 may be implemented without the authoritative data source 54 and/or without the downstream process 56. In one example, the memory consolidation system 102 may be configured to perform operations for Anthropic's Claude “Dreaming”, announced on May 6, 2026. In some embodiments, the memory consolidation system 102 may implement forward binding and/or authoritative content binding. Generally, operations for the forward binding and/or authoritative content binding may utilize the authoritative data source 54 and/or the downstream process 56. The Claude “Dreaming” architecture provides basic memory consolidation. The forward binding and authoritative content binding described herein constitute additional architectural features beyond those publicly disclosed in the Claude “Dreaming” architecture.

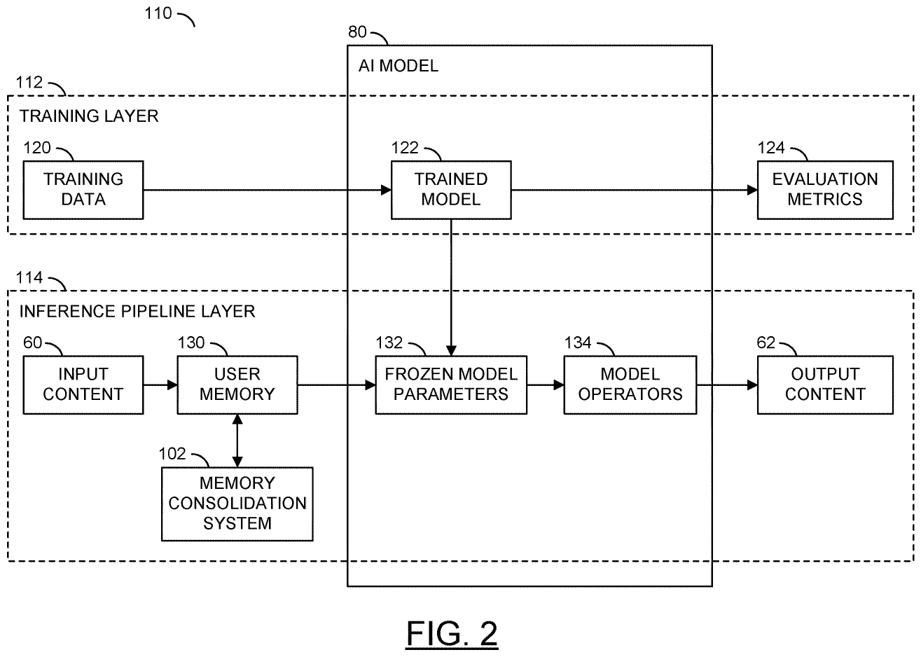

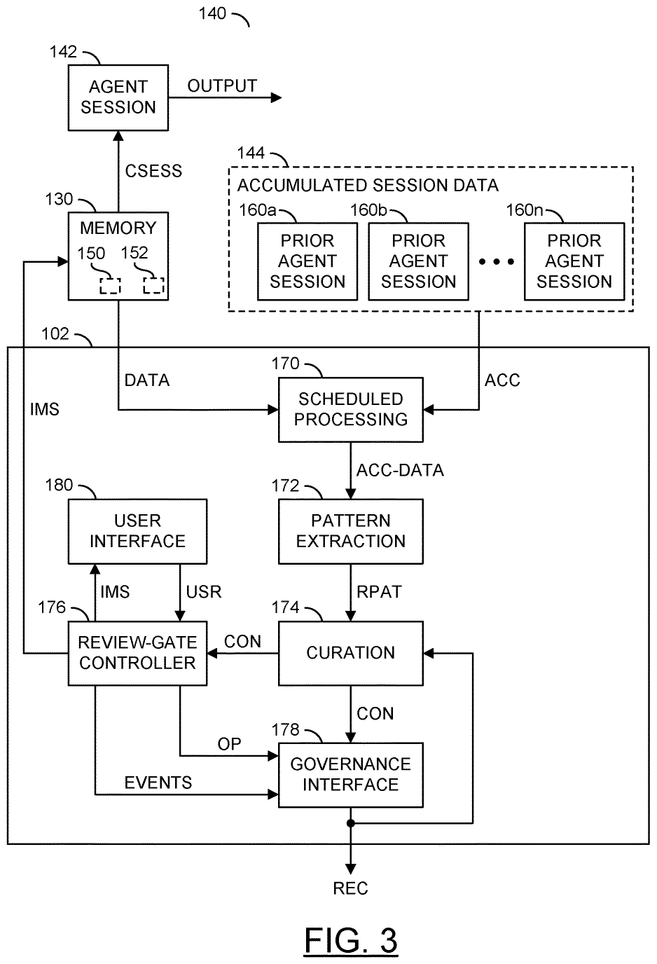

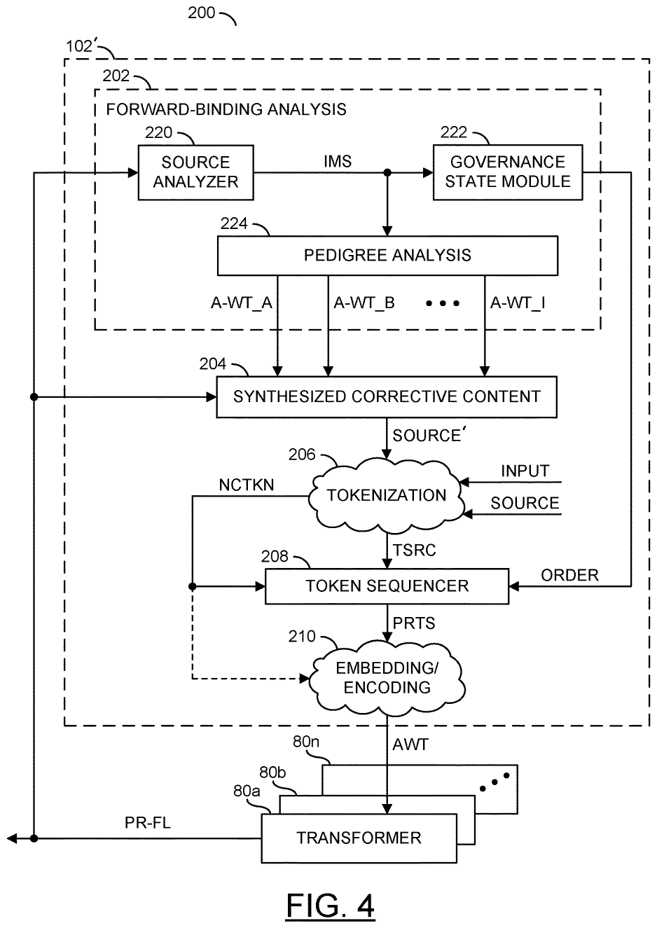

The memory consolidation system 102 may be a memory-consolidation subsystem. In some embodiments, the memory consolidation system 102 may operate within a broader governance layer (e.g., the governance layer 100). In some embodiments, the memory consolidation system 102 may generate a independent memory store that may be supplied to a governance architecture configured to generate synthesized governance content for subsequent conversational turns. The architecture of the memory consolidation system 102 described herein was disclosed in one or more applications filed in November of 2025. The present application incorporates and/or expands upon those previous disclosures. The description of subsequently released products is provided as an illustrative example of architectures contemplated by the earlier disclosures and is not intended to limit the scope of the invention. Although certain commercial implementations became publicly available after the November 2025 date of the priority filings, the architectural elements described herein were disclosed prior to such public releases and are presented in this application to illustrate correspondence between the disclosed architecture and later implementations. Such systems provide useful examples for understanding the operation and commercial significance of the architectures described herein. One representative example is discussed below. The present application further develops those architectures and describes additional implementations, refinements, and/or use cases that became commercially relevant following the earlier disclosures. The memory-consolidation embodiments described below may be implemented independently or as part of broader conversational control architectures. Details of the memory consolidation system 102 may be described in association with FIGS. 2-3 and details of further refinements to the memory consolidation system 102 may be described in association with FIG. 4. The number, type and/or arrangement of the components of the apparatus 100 may be varied according to the design criteria of a particular implementation.

Referring to FIG. 2, a block diagram illustrating an architectural separation of a training layer and a memory consolidation system implemented in an inference-pipeline layer is shown. A block diagram 110 is shown. The block diagram 110 may provide an architectural separation diagram of an AI engine 80. The AI engine 80 may be a representative example of one of the transformer models 80a-80n shown in association with FIG. 1. For example, the architectural separation diagram 110 may be a language-model agent environment.

The architectural separation diagram 110 may comprise the AI engine 80, a layer 112 and/or a layer 114. The layer 112 may be a training layer. The layer 114 may be an inference pipeline layer 114. The training layer 112 and the inference pipeline layer 114 may be conceptual layers that correspond to the AI engine 80. Both the training layer 112 and the inference pipeline layer 114 may be visualized as partially within the AI engine 80 and partially outside of the AI engine 80, which may illustrate that the training layer 112 and the inference pipeline layer 114 may comprise input to the AI engine 80, components and/or functionality of the AI engine 80, and output of the AI engine 80. The AI engine 80 may comprise other layers (not shown) for simplicity. For example, the AI engine 80 may comprise an orchestration layer. The number, type and/or function of layers implemented in relation to the AI engine 80 may be varied according to the design criteria of a particular implementation.

The training layer 112 and the inference pipeline layer 114 may be separate functional layers. Generally, the operations, input and/or output of the training layer 112 and the inference pipeline layer 114 may be independent. Some of the results generated by the training layer 112 may affect operations of the inference pipeline layer 114. However, the inference pipeline layer 114 may be generally functionally separate from the training layer 112. The operations of the training layer 112 and/or the inference pipeline layer 114 may share resources (e.g., operations may be performed by hardware implemented by the user devices 52a-52n, the server computers 70a-70n and/or other computing devices).

The training layer 112 may comprise a block 120, a block 122 and/or a block 124. The block 120 may represent training data. The block 122 may represent a trained model. The block 124 may represent evaluation metrics. The training layer 112 may comprise other data and/or functionality (not shown). For example, the training layer 112 may comprise a data pipeline, a loss function, an optimizer, a backpropagation engine, gradients, a learning rate scheduler, etc. The number, type and/or arrangement of the components and/or data of the training layer 112 may be varied according to the design criteria of a particular implementation.

The training data 120 may comprise input for the training layer 112. The training data 120 may be generated offline and/or before the AI engine 80 is operational. The training data 120 may be retrieved from various sources. For example, for a large language model, the training data 120 may comprise labeled input from end users, data scraped from websites, transcriptions of books (or other writing), etc. In another example, for a vision language model, the training data 120 may comprise labeled video frames. The training data 120 may be continually and/or regularly provided to the AI engine 80 to update the trained model 122. The type and/or source of the training data 120 may be varied according to the design criteria of a particular implementation.

The trained model 122 may comprise weights, biases and/or other parameters of the AI engine 80. The trained model 122 may be stored as part of the AI engine 80. The trained model 122 may comprise numerical values stored in a neural network after training. The trained model 122 may be learned from the training data 120. In some embodiments, the trained model 122 may comprise encodings that have been compressed into parameters from the training data 120. The trained model 122 may be presented to the inference pipeline layer 114 to enable the inference operations to be performed. Generally, data from the inference pipeline layer 114 does not affect and/or change the trained model 122 during operation. In some embodiments, the output of the inference pipeline layer 114 may be repackaged as part of the training data 120. In some embodiments, the trained model 122 may generate an output for the training layer 112. The output of the training layer 112 may be the evaluation metrics 124. The evaluation metrics 124 may be fed back into the trained model 122 as part of the training data 120. For example, the evaluation metrics 124 may comprise validation loss signals, evaluation benchmarks, reward signals, synthetic data, error analysis logs, etc.

The inference pipeline layer 114 may comprise the input content 60, the output content 62, the memory consolidation system 102, a block 130, a block 132, and/or block 134. The block 130 may represent user memory. The block 132 may represent frozen model parameters. The block 134 may represent model operators. The inference pipeline layer 114 may comprise other data and/or functionality (not shown). For example, the inference pipeline layer 114 may comprise a tokenizer, a context window, an attention mechanism, a key-value cache, a runtime engine, etc. The number, type and/or arrangement of the components and/or data of the inference pipeline layer 114 may be varied according to the design criteria of a particular implementation.

The input content 60 may comprise input for the inference pipeline layer 114. The input content 60 may be presented to the AI engine 80 from an external source. For example, the input content 60 may be presented to the inference pipeline layer 114 from one or more of the user devices 52a-52n.

The user memory 130 may comprise a persistent memory store and/or other data. For example, the user memory 130 may comprise a context window and/or a key-value cache. The user memory 130 may be configured to store an independent memory store generated by the memory consolidation system 102. In the example shown, the user memory 130 may be illustrated in the inference pipeline layer 114 external to the user devices 52a-52n and the AI engine 80. In some embodiments, the user memory 130 may be stored on the user devices 52a-52n. In some embodiments, the user memory 130 may be stored on the AI engine 80. In some embodiments, the user memory 130 may reside partially on both the user devices 52a-52n and the AI engine 80 (e.g., on the server computers 70a-70n) and/or may be synchronized across devices. The location and/or the type of data stored in the user memory 130 may be varied according to the design criteria of a particular implementation.

The frozen model parameters 132 may comprise the weights of the trained model 122 at a particular time that the inference operations are being performed by the inference pipeline layer 114. The frozen model parameters 132 may comprise the static values of the weights that may be used by the model operators 134. For example, the trained model 122 may be dynamically updated from the training data 120 and the frozen model parameters 132 may be frozen values that may be used for the inference operation. The frozen model parameters 132 may represent a handoff point from the trained model 122 to the inference pipeline layer 114. The operations of the memory consolidation system 102 do not affect the training layer 112.

The model operators 134 may be configured to perform the inference operations and/or generate the output content 62. The input content 60 and data from the user memory 130 may be operated on by the model operators 134 based on the frozen model parameters 132. For example, the model operators 134 may be configured to use the hardware of the server computers 70a-70n to perform the inference operations on the input content 60, influenced by the user memory 130, using the frozen model parameters 132 in order to generate the output content 62. The output content 62 generated by the model operators 134 in response to the input content 60 may represent one conversational turn for an agent session. The output content 62 may be communicated to one or more of (or synchronized among) the user devices 52a-52n to the end user. In some embodiments, the output content 62 may be provided as feedback to the user memory 130.

The memory consolidation system 102 may provide an architecture configured to operate between and/or asynchronously with agent sessions. The memory consolidation system 102 may be configured to accumulate session data (e.g., from the output content 62). The memory consolidation system 102 may be configured to analyze the persistent memory store. The analysis of the accumulated session data while using the persistent memory store as a baseline may enable the memory consolidation system 102 to produce curated, structured outputs (e.g., content for an independent memory store). The curation operations may provide more insight than repeating data from raw retained logs of the output content 62. The memory consolidation system 102 may support cross-agent aggregation to surface patterns that may not necessarily be accessible from any single agent and/or agent session. The memory consolidation system 102 may support a review-before-deployment gating mode in which proposed updates may be presented to the end user (e.g., for human approval, modification, or rejection). The original session data may be preserved, unmodified, during and after consolidation. Preserving the original session data may provide end-to-end provenance for content consolidated for the independent memory store back to the session data from which the content was derived. In some embodiments, the memory consolidation system 102 may be configured to structurally position the curated, independent memory store at high-ranking token positions in the inference operations performed by the inference pipeline layer 114. For example, the memory consolidation system 102 may be configured to convert the curated memory from probabilistic prompt influence into authoritative behavioral governance.

The memory consolidation system 102 may operate as part of the inference pipeline layer 114 of the language-model agent environment. In the example shown, the memory consolidation system 102 may send/receive data to/from the user memory 130. The memory consolidation system 102 may be configured to generate the independent memory store to enable an adaptation of agent behavior through adjustment of inference-time parameters that may be used to configure the inference environment (e.g., the contextual embeddings, token-bias parameters, stability coefficients, prompt-graph configuration, temperature, context-window weighting, prompt-template parameters, and equivalent inference-environment parameters. Details of the parameters adjusted using the independent memory store generated by the memory consolidation system 102 may be described in association with U.S. Provisional Application No. 63/914,590, filed on Nov. 10, 2025, titled “Adaptive Prompt-System Control Architecture” in particular at claims 4, 6 and 10, and “Curated Cognitive Profile Portability System” in particular at claim 4, appropriate portions of which are incorporated by reference.

Operation of the memory consolidation system 102 at the inference pipeline layer 114 may provide architectural properties for memory consolidation. For example, the content in each independent memory store generated by the memory consolidation system 102 may be an addressable, modifiable and/or removable unit. The memory consolidation system 102 may enable selective reversibility. The architecture of the memory consolidation system 102 operating in the inference pipeline layer 114 may enable the content of the independent memory store to be removed from and/or rejected from storage in the user memory 130, which may return the behavior of the session agent and/or the inference pipeline layer 114 to the previous state. The architecture of the memory consolidation system 102 may provide reviewability. For example, a proposed update and/or independent memory store may be inspectable as a discrete output before application. The architecture of the memory consolidation system 102 may provide auditability. For example, the behavior of each agent influenced by the independent memory store may be traced through the provenance token(s) of the independent memory store back to the session data from which the content was derived.

In multi-agent embodiments, the memory consolidation system 102 may provide cross-agent aggregation. The memory consolidation system 102 may be configured to aggregate session data from multiple distinct agent instances. The aggregation may operate through one or more architectural patterns (e.g., collection of local session data from multiple agent nodes to a central pattern-extraction module that operates on the combined data, hierarchical sub-herd aggregation in which local pattern-extraction operates per agent and/or per sub-team and produces local aggregates that are then aggregated at a higher tier, cross-agent convergence weighting in which patterns that are independently arrived at by multiple distinct agents receive higher weight in the curation output than patterns originating in session data of a single agent, etc.). Details of the aggregation of the session data may be described in association with U.S. Provisional Application No. 63/912,463, filed on Nov. 6, 2025, titled “Contrastive Memory-Resonance System for Character-Aware Context” in particular at claims 9 and 12, “Collaborative Trait Ingest Filter (CTIF)” in particular at claim 11, “Cognitive Compression Prioritization and Fusion Memory System” in particular at claim 12, and “Public Collaborative Trait-Exchange and Collective Resonance Mapping System” and/or U.S. Provisional Application No. 63/914,590, filed on Nov. 10, 2025, titled “Adaptive Herd-Coherence Engine” in particular at claim 9, appropriate portions of which are incorporated by reference.

The cross-agent aggregation may be configured to identify patterns that may not necessarily be capable of being identified by a single agent alone. For example, a recurring mistake may affect three of five agents in a team. The memory consolidation system 102 may enable an identification as a team-wide pattern even though no single agent has visibility into the sessions of other agents. A convergent workflow that two agents arrived at independently may be identified as a shared discovery and consolidated into the team-wide independent memory store generated by the memory consolidation system 102. A preference shared across deployment groups may be surfaced and made available to subsequent agent sessions across the deployment.

### Memory Consolidation Independent of Specific Commercial Implementations

Although publicly available systems may implement selected aspects of memory consolidation, the embodiments described herein are not limited to any particular implementation. The disclosed architecture encompasses scheduled processing, pattern extraction, curation, review gating, provenance management, memory transformation, and other mechanisms that may be implemented individually or in combination.

Referring to FIG. 3, a block diagram illustrating a memory consolidation system is shown. A block diagram 140 is shown. The block diagram 140 may provide a memory consolidation architecture. The memory consolidation architecture 140 may comprise the memory consolidation system 102, the user memory 130, a block 142 and/or a block 144. The block 142 may be an agent session. The block 144 may be accumulated session data. The user memory 130, the agent session 142 and/or the accumulated session data 144 may generally be content external to the memory consolidation system 102. The memory consolidation architecture 140 may comprise other components and/or data (not shown). The number, type and/or arrangement of the memory consolidation architecture 140 may be varied according to the design criteria of a particular implementation.

The user memory 130 may comprise a block 150 and/or a block 152. The block 150 may represent an independent memory store. The block 152 may represent a persistent memory store. The independent memory store 150 may comprise a consolidated memory store generated by the memory consolidation system 102 and/or applied to the user memory 130. The independent memory store 150 may be distinct and/or separate from the persistent memory store 152. For example, one of and/or both of the independent memory store 150 and the persistent memory store 152 may be presented as input to the agent session 142.

The persistent memory store 152 may comprise existing memory architectures for language-model agents. The persistent memory store 152 may capture raw interaction data but is not curated interaction data. The persistent memory store 152 may comprise session logs grown without restrictive bounds, redundant entries accumulated as the same patterns recur across agent sessions, outdated information persisting alongside current information without a mechanism for distinguishing the two. In contrast, cross-agent patterns (e.g., workflows that multiple agent sessions converge on independently, mistakes that recur across a team of agents, preferences shared across deployment groups) may be captured in the independent memory store 150. When only the persistent memory store 152 is queried during a subsequent agent session, the retrieval may be content-similarity-based and/or probabilistic.

The persistent memory store 152 may comprise a collection of documents and/or files. In some embodiments, the persistent memory store 152 may be attached to a particular agent session. For example, for an agent session that uses the persistent memory store 152 (or the independent memory store 150) as input, the memory store may be mounted as a directory of files. The agent may read and/or write to the files of the persistent memory store 152. The independent memory store 150 and/or the persistent memory store 152 may be addressed by the agent based on a file and/or directory path for tuning, importing and/or exporting. The independent memory store 150 and/or the persistent memory store 152 may each persist beyond any single agent session (e.g., stored in the user memory 130). In some embodiments, the agent session 142 may be configured to write to the independent memory store 150 and/or the persistent memory store 152. In some embodiments, the independent memory store 150 may be a read-only memory store with respect to the agent session 142 (e.g., only the memory consolidation system 102 may enable modifications to the independent memory store 150). Generally, an immutable copy of the independent memory store 150 and/or the persistent memory store 152 may be generated before any modifications, which may enable an audit trail.

The agent session 142 may represent operations performed by the AI engine 80. The agent session 142 may be configured to perform tasks on behalf of the user (e.g., provide text responses in a natural language, generate code, generate artifacts, generate documents in a particular format, etc.). In the example shown, the agent session 142 may represent a subsequent agent session. For example, the memory consolidation system 102 may operate on data previously generated (e.g., data in the user memory 130 and/or the accumulated session data 144) to provide guidance and/or influence for the subsequent agent session 142. The agent sessions generally comprise a conversational turn. For example, the end user may provide the AI engine 80 with a goal and/or a request. The agent session may plan on how to accomplish the goal/request, then perform one or more actions to achieve the goal and/or satisfy the request. Then the agent may observe the output of the action. For example, the user may give the agent session feedback on the action and/or provide another goal/request. While the agent session may be referred to as a conversational turn with respect to a LLM, the conversational turn may comprise multiple back-and-forth interactions between the end user and the AI engine 80. Each agent session may have a session identifier to uniquely represent the agent session. Each agent session may be distinguished from each other based on a particular goal/request, temporally, a selection by the end user, a contextual isolation, access permissions, etc. Each of the agent sessions, the data generated and/or received by each agent session and/or the difference between each of the agent sessions may be varied according to the design criteria of a particular implementation.

The accumulated session data 144 may comprise data from multiple agent sessions performed previously. The accumulated session data 144 may comprise a number of blocks 160a-160n. The blocks 160a-160n may each comprise a prior agent session. The prior agent sessions 160a-160n may comprise data and/or a record of previous interactions between the end user and the AI engine 80. For example, each of the prior agent sessions 160a-160n may comprise past session transcripts of conversational turns between the user and output from the transformer models 80a-80n. While each of the prior agent sessions 160a-160n may comprise previously generated information, each of the prior agent sessions 160a-160n are not necessarily considered ‘completed’. For example, the end user may select one of the prior agent sessions 160a-160n as the subsequent agent session 142 (e.g., to continue where a previous interaction with the agent session left off). The number of the prior agent sessions 160a-160n may be varied according to the design criteria of a particular implementation.

The memory consolidation system 102 may receive a signal (e.g., DATA) and/or a signal (e.g., ACC). The signal DATA may comprise the persistent memory store 152. The signal ACC may comprise accumulated session data from one or more of the prior agent sessions 160a-160n. The memory consolidation system 102 may generate a signal (e.g., IMS) and/or a signal (e.g., REC). The signal IMS may comprise the independent memory store 150. The signal REC may comprise an auditable record of operations performed and/or data generated by the memory consolidation system 102. The signal DATA may be received from the user memory 130. The signal ACC may be received from the accumulated session data 144. The signal IMS may be presented to the user memory 130. The signal REC may be output to an external component and/or another component in the inference pipeline layer 114. The memory consolidation system 102 may generate and/or receive other signals and/or data (not shown). The number, format and/or data communicated by the memory consolidation system 102 may be varied according to the design criteria of a particular implementation.

The memory consolidation system 102 may comprise a block (or circuit) 170, a block (or circuit) 172, a block (or circuit) 174, a block (or circuit) 176 and/or a block (or circuit) 178. The circuit 170 may implement a scheduled processing module. The circuit 172 may implement a pattern extraction module. The circuit 174 may implement a curation module. The circuit 176 may implement a review-gate controller. The circuit 178 may implement a governance interface. The memory consolidation system 102 may comprise other components (not shown). For example, the memory consolidation system 102 may further provide a user interface 180. Generally, the scheduled processing module 170, the pattern extraction module 172, the curation module 174, the review-gate controller 176, the governance interface 178 may comprise five coordinated modules. In some embodiments, the modules 170-178 may be implemented as hardware circuits. In some embodiments, the modules 170-178 may be implemented as computer readable instructions that may be executable by one or more processors (e.g., hardware implemented by the user device 52 and/or the server computers 70a-70n). The number, type and/or arrangement of the components of the memory consolidation system 102 may be varied according to the design criteria of a particular implementation.

The scheduled processing module 170 may be configured to receive the signal DATA and/or the signal ACC. The scheduled processing module 170 may be configured to operate on the data from the user memory 130 (e.g., data from the persistent memory store 152) and the accumulated session data 144 from the prior agent sessions 160a-160n. The scheduled processing module 170 may be triggered by a temporal schedule, a session-count threshold, a memory-store size threshold, an external command, etc. In one example, the scheduled processing module 170 may be configured to operate between agent sessions. The operation of the scheduled processing module 170 may occur in a context window and/or an isolated memory location separated from active agent execution (e.g., the subsequent agent session 142). In some embodiments, the scheduled processing module 170 may operate concurrently with the active agent execution. Isolating the scheduled processing module 170 from the active agent execution may enable batched processing of accumulated content without interference with concurrent session activity. In some embodiments, the scheduled processing module 170 may be configured to pause-and-resume for agents with memory stores actively being processed. In some embodiments, the scheduled processing module 170 may be scheduled according to resource allocation (e.g., resource allocation between memory consolidation processing and inference workloads). The memory consolidation system 102 may be configured to handle failures in operation by rolling back processing of the memory consolidation system 102 if processing is interrupted. The scheduled processing module 170 may re-schedule the memory consolidation operations after an interruption. The scheduled processing module 170 may be configured to generate a signal (e.g., ACC-DATA) in response to the signal DATA and/or the signal ACC. The signal ACC-DATA may comprise the accumulated session data 144 and/or data from the persistent memory store 152. The signal ACC-DATA may be presented to the pattern extraction module 172. Details of the scheduled processing module 170 may be described in association with U.S. Provisional Application No. 63/911,540, filed on Nov. 5, 2025, titled “Readiness Detection and Adaptive Engagement System” in particular at claim 12, U.S. Provisional Application No. 63/912,463, filed on Nov. 6, 2025, titled “Contrastive Memory-Resonance System for Character-Aware Context” in particular at claim 12(e), and “Guided Cognitive Drift System with Cross-Thread Re-Anchoring” in particular at claim 1(e), and/or U.S. Provisional Application No. 63/914,590, filed on Nov. 10, 2025, titled “Adaptive Prompt-System Control Architecture” in particular at claims 6 and 8, and “Adaptive Herd-Coherence Engine”, appropriate portions of which are incorporated by reference.

The pattern extraction module 172 may receive the signal ACC-DATA. The pattern extraction module 172 may be configured to identify recurring patterns across the accumulated session data 144 and/or based on the persistent memory store 152. In one example, the pattern extraction module 172 may be configured to perform deduplication operations on the information in the persistent memory store 152. In another example, the pattern extraction module 172 may use the information in the persistent memory store 152 as baseline data for memory consolidation (e.g., a baseline for identifying the recurring patterns across the accumulated session data 144). The persistent memory store 152 may comprise content from one or more consolidation operations based on the prior agent sessions 160a-160n. In single-agent embodiments, the pattern extraction module 172 may perform recurrence detection, clustering of similar interaction patterns, and/or persistence scoring across sessions for an individual agent (e.g., the prior agent session 160a). In multi-agent embodiments, the pattern extraction module 172 may perform cross-agent aggregation, identify patterns that may span multiple distinct agent instances (e.g., the prior agent sessions 160a-160n). The patterns identified by the pattern extraction module 172 across multiple of the prior agent sessions 160a-160n may comprise patterns that may not necessarily be detectable within session data of any one of the prior agent sessions 160a-160n alone.

Categories of patterns identified by the pattern extraction module 172 may comprise recurring mistakes, convergent workflows that multiple agents arrive at independently, shared preferences across deployment groups, team-wide outcome characteristics, similar interaction patterns, etc. For example, the pattern extraction module 172 may perform clustering methods to identify the similar interaction patterns. The pattern extraction module 172 may apply a persistence scoring formula to the accumulated data to identify the recurring patterns. The pattern extraction module 172 may implement one or more cross-agent aggregation architectures (e.g., flat aggregation, hierarchical sub-herd, cross-source convergence weighting, etc.). The pattern extraction module 172 may track a pattern category taxonomy and/or quality metrics for pattern identification. The pattern extraction module 172 may be configured to generate a signal (e.g., RPAT) in response to the signal ACC-DATA. The signal RPAT may comprise the recurring patterns identified by the pattern extraction module 172. The signal RPAT may further comprise persistence scores and/or cross-agent presence metadata. The signal RPAT may be presented to the curation module 174. Details of the pattern extraction module 172 may be described in association with U.S. Provisional Application No. 63/912,463, filed on Nov. 6, 2025, titled “Cognitive Compression Prioritization and Fusion Memory System” in particular at claim 5 and 12, “Contrastive Memory-Resonance System for Character-Aware Context” in particular at claim 12(c), and “Collaborative Trait Ingest Filter (CTIF)” in particular at claim 11, and/or U.S. Provisional Application No. 63/914,590, filed on Nov. 10, 2025, titled “Adaptive Herd-Coherence Engine” in particular at claim 9 and “Adaptive Readiness-Gated Reasoning System”, appropriate portions of which are incorporated by reference.

The curation module 174 may receive the signal RPAT and/or the signal REC). The curation module 174 may be configured to transform the identified recurring patterns into content for an independent memory store (e.g., for the independent memory store 150). In one example, the curation module 174 may transform the recurring patterns identified by the pattern extraction module 172 into structured update artifacts. The content for the independent memory store 150 may be generated in response to transforming the identified recurring patterns into playbooks, notes and/or other curated output. Curation operations performed by the curation module 174 may comprise merging new artifacts and/or content against existing entries in the persistent memory store 152 with overlap detection and consolidation of overlapping entries. The curation operations may comprise filtering patterns by persistence score with retention of stable patterns and purging of transient noise. The curation operations may comprise incremental update operations that may compare new content against an existing model state and merging verified changes while retaining unmodified entries. The curation module 174 may be configured to merge the content for the independent memory store 150 with the data from the persistent memory store 152 by one or more of a comparison of the content against existing entries in the persistent memory store 152, identifying redundant entries in response to the comparison, and consolidating the redundant entries while preserving non-redundant content.

The curation module 174 may implement one or more transformation operations configured to transform the identified patterns into content for the independent memory store 150. Merge operations implemented by the curation module 174 may comprise overlap detection, semantic-similarity thresholds for overlap, consolidation rules for overlapping entries, preservation rules for non-overlapping content, etc. Filter operations implemented by the curation module 174 may comprise persistence-score thresholding rules, decay functions for transient noise, retention policies, etc. Incremental update operations implemented by the curation module 174 may comprise a comparison of new content against an existing model state, merge verification, retention of unmodified entries, etc. The curation module 174 may generate a signal (e.g., CON) in response to the signal RPAT and/or the signal REC. The signal CON may comprise the content generated by the curation module 174. The structure of the content generated by the curation module 174 may comprise the content, metadata, provenance tags, application targets, impact magnitude scores, etc. The signal CON may be presented to the review-gate controller 176 and/or the governance interface 178. Details of the curation module 174 may be described in association with U.S. Provisional Application No. 63/912,463, filed on Nov. 6, 2025, titled “Adaptive Baseline Management System for Iterative Cognitive Exploration” in particular at claims 1(d), 1(e), 6 and 8, “Cognitive Compression Prioritization and Fusion Memory System” in particular at claim 7 and 14(e), and “Narrative-Derived Character Modeling System with Thread Isolation” in particular at claim 6, and/or U.S. Provisional Application No. 63/914,590, filed on Nov. 10, 2025, titled “Author-Controlled Resonance-Mapping Engine” in particular at claim 1(c) and 1(e), and “Curated Cognitive Profile Portability System” in particular at claim 7, appropriate portions of which are incorporated by reference.

The review-gate controller 176 may be configured to receive the signal CON and/or a signal (e.g., USR). The signal USR may comprise user input and/or user feedback. The review-gate controller 176 may be configured to generate the independent memory store 150 according to a mode of operation. The review-gate controller 176 may operate in one of at least two modes of operation. One mode of operation may be an automatic mode of operation. In the automatic mode of operation, the review-gate controller 176 may apply the independent memory store 150 to the user memory 130 without an intervening action from the end user. Another mode of operation may be a review mode of operation. In the review mode of operation, the review-gate controller 176 may present the independent memory store 150 to the end user to enable the end user to provide feedback for the content in the independent memory store 150 prior to the review-gate controller 176 applying the independent memory store 150 to the user memory 130.

The review-gate controller 176 may generate the signal IMS, a signal (e.g., OP) and/or a signal (e.g., EVENTS) in response to the signal CON. The signal IMS may comprise the data for the independent memory store 150. In the automatic mode of operation, the review-gate controller 176 may communicate the signal IMS to the user memory 130. In the review mode of operation, the review-gate controller 176 may first communicate the signal IMS to the user interface 180. The end user may interact with the user interface 180 to review and/or provide feedback about the content generated by the memory consolidation system 102 for the independent memory store 150. The signal USR may comprise the user feedback. The signal USR may comprise an acceptance, a rejection and/or modification data. If the end user rejects the content for the independent memory store 150, the review-gate controller 176 does not present the signal IMS to the user memory 130. If the end user accepts the content for the independent memory store 150, the review-gate controller 176 may present the signal IMS to the user memory 130. If the end user provides modifications, the review-gate controller 176 may update the content for the independent memory store 150 with the modifications provided by the end user before communicating the signal IMS to the user memory 130. The signal OP may comprise a number of operations performed by the review-gate controller 176. The signal EVENTS may comprise events related to the independent memory store 150 performed by the review-gate controller 176. For example, the signal EVENTS may comprise a log of when the independent memory store 150 has been accepted, rejected and/or modified.

In some embodiments, the review-gate controller 176 may be configured to present the content and/or the structured update artifacts to the user interface 180 in a review queue ranked by impact magnitude and/or accompanied by contextual analytics (e.g., including before-and-after representations of the existing memory store, a provenance trail back to the session data in the accumulated session data 144, etc.). For example, the metadata provided by the curation module 174 may indicate the impact magnitude. Rejected updates and the rationale (if any provided by the end user) for rejection may be recorded in a rejection log (e.g., the signal EVENTS) and fed back to the curation module 174 (e.g., via the signal REC) to refine subsequent update generation. Mode selection for the review-gate controller 176 may be configured on a per-deployment basis, per artifact category, per impact magnitude threshold, dynamically based on system performance, rejection rates, etc.

The review-gate controller 176 may be configured to queue the content for the independent memory store 150 for review. In some embodiments, the review-gate controller 176 may implement ranking techniques for queuing the data. For providing contextual data, the review-gate controller 176 may be configured to generate before-and-after representations, perform impact magnitude computations, implement provenance trail rendering, etc. The review-gate controller 176 may be configured to process user commands (e.g., semantics for accept commands, reject commands, modify commands, etc.). The review-gate controller 176 may be configured to handle updates for the independent memory store 150 and/or generate structured rejection logs. The signal IMS may be presented to the user interface 180 and/or the user memory 130. The signal EVENTS and/or the signal OP may be presented to the governance interface 178. Details of the review-gate controller 176 may be described in association with U.S. Provisional Application No. 63/911,540, filed on Nov. 5, 2025, titled “Mix Control Model-Adaptive Cognitive Balancing System”, U.S. Provisional Application No. 63/912,463, filed on Nov. 6, 2025, titled “Adaptive Baseline Management System for Iterative Cognitive Exploration” in particular at claims 1(b) and 1(c), and/or U.S. Provisional Application No. 63/914,590, filed on Nov. 10, 2025, titled “Author-Controlled Resonance-Mapping Engine” in particular at claims 1(d), 5 and 6, and “Adaptive Herd-Coherence Engine” in particular at claims 1(f) and 8, appropriate portions of which are incorporated by reference.

The governance interface 178 may receive the signal CON, the signal OP and/or the signal EVENTS. The governance interface 178 may be configured to record the independent memory store 150, application events related to the independent memory store 150, and/or operations of the review-gate controller 176 in an auditable record. The auditable record may be provided as feedback to the curation module 174. The curation module 174 may be configured to generate the content for the independent memory store 150 partially in response to the auditable record. The independent memory store 150 may be associated with a provenance token comprising at least one of a cryptographic hash, a source identifier, a timestamp, and/or a link to one or more session identifiers from which the independent memory store 150 was derived. The governance interface 178 may implement an audit-reconstruction interface that may enable a regeneration of original content upon authorization using the stored provenance data.

The governance interface 178 may be configured to implement a data structure for the auditable record. The governance interface 178 may be configured to implement provenance token construction. The provenance token construction may comprise cryptographic hash techniques, source identifier formats, timestamp standards, session-identifier link structures, etc. The governance interface 178 may be configured to implement audit-reconstruction. The audit reconstruction may comprise regeneration techniques, authorization protocols, output formats, etc. The governance interface 178 may integrate external oversight. The external oversight may comprise a governance-report file format, oversight-system protocols, performance certification interfaces, policy auditing interfaces, etc. The governance interface 178 may generate the signal REC in response to the signal CON, the signal OP, and/or the signal EVENTS. The signal REC may comprise the auditable record. The signal REC may be provided to the curation module 174. In some embodiments, the signal REC may be an output of the memory consolidation system 102. For example, the signal REC may be provided for debug and/or error testing. Details of the governance interface 178 may be described in association with U.S. Provisional Application No. 63/911,540, filed on Nov. 5, 2025, titled “Readiness Detection and Adaptive Engagement System (Secretary Gate)” in particular at claim 6, U.S. Provisional Application No. 63/912,463, filed on Nov. 6, 2025, titled “Cognitive Compression Prioritization and Fusion Memory System” in particular at claim 8 and 14(f), “Collaborative Trait Ingest Filter (CTIF)” in particular at claim 4, “Guided Cognitive Drift System with Cross-Thread Re-Anchoring” in particular at claim 4(b), and “Public Collaborative Trait-Exchange and Collective Resonance Mapping System” in particular at claim 2, and/or U.S. Provisional Application No. 63/914,590, filed on Nov. 10, 2025, titled “Adaptive Herd-Coherence Engine” in particular at claim 10, “Author-Controlled Resonance-Mapping Engine” in particular at claims 1(e) and 7, and “Curated Cognitive Profile Portability System”, appropriate portions of which are incorporated by reference.

The user interface 180 may be a user node that may be configured to expose the independent memory store 150 to the end user and/or receive input from the end user. In some embodiments, the user interface 180 may be implemented by the memory consolidation system 102. In some embodiments, the user interface 180 may be an API provided by the AI engine 80, the inference pipeline layer 114 and/or the server computers 70a-70n. The end user may interact with the user interface 180 to accept the proposed update (e.g., in which case the update for the independent memory store 150 may be applied to the user memory 130 and the application event recorded by the governance interface 178. The end user may interact with the user interface 180 to reject the proposed update (e.g., in which case the update for the independent memory store 150 is not applied to the user memory 130, and the rejection and/or the rationale may be recorded in a rejection log by the governance interface 178, and the rejection log may be fed back to the curation module 174 to refine subsequent update generation). The end user may interact with the user interface 180 to modify the proposed update for the independent memory store 150 (e.g., in which case the modified version may replace the content for the independent memory store 150 and the independent memory store 150 may be applied to the user memory 130 with the modification recorded. The user interface 180 may receive the proposed update along with contextual analytics that may comprise before-and-after representations of the affected portion of the memory store, an impact magnitude score, the provenance trail back to the session data from which the update was derived, etc. Details of the user interface 180 and/or receiving feedback from the end user may be described in association with U.S. Provisional Application No. 63/914,590, filed on Nov. 10, 2025, titled “Author-Controlled Resonance-Mapping Engine”, appropriate portions of which are incorporated by reference.

The signal IMS may comprise the data, content and/or metadata for the independent memory store 150. The independent memory store 150 may be referenceable by the subsequent agent session 142. The signal IMS may be applied according to the mode of operation of the review-gate controller 176. The independent memory store 150 may be applied as one source for an input to influence and/or guide behavior of the subsequent agent session 142. The user memory 130 may present a signal (e.g., CSESS). The signal CSESS may be the input for the subsequent agent session 142. In one example, the independent memory store 150 may be provided to the subsequent agent session 142 instead of the persistent memory store 152 (e.g., the independent memory store 150 may replace the persistent memory store 152). In another example, the independent memory store 150 may be provided to the subsequent agent session 142 in addition to the persistent memory store 152 (e.g., the independent memory store 150 may provide additional context for the persistent memory store 152). In yet another example, only the persistent memory store 152 may be provided to the subsequent agent session 142 (e.g., the independent memory store 150 may be selectively provided to the subsequent agent session 142). While only one agent session is shown representing the subsequent agent session 142. The independent memory store 150 may be provided to multiple subsequent agent sessions (e.g., multiple concurrent subsequent agent sessions and/or multiple sequential subsequent agent sessions). After the subsequent agent session 142, the subsequent agent session 142 may become one of the prior agent sessions 160a-160n of the accumulated session data 144, which may be provided to the memory consolidation system 102 for further updates to the independent memory store 150 (e.g., the memory consolidation operations may be an iterative and/or continually evolving process). The number, type and/or whether the independent memory store 150 is applied to the subsequent agent session 142 may be varied according to the design criteria of a particular implementation.

The subsequent agent session 142 may be configured to generate a signal (e.g., OUTPUT). The signal OUTPUT may be generated in response to the signal CSESS. The signal OUTPUT may be output communicated to the end user. For example, the signal OUTPUT may comprise data for a conversational turn and/or an agent session. In some embodiments, when the independent memory store 150 is not provided as the input to the subsequent agent session 142, the signal OUTPUT may be generated in response to the user input (e.g., the signal REQUEST) and/or the persistent memory store 152. In some embodiments, when the independent memory store 150 is provided as the input (or part of the input) to the subsequent agent session 142, the signal OUTPUT may be generated in response to one or more of the user input in the signal REQUEST, the independent memory store 150 and/or the persistent memory store 152. In one example, the subsequent agent session 142 may decide which combination of inputs to request as part of the agent session. In another example, user configuration settings, preferences and/or available tokens may determine which combination of inputs to request as part of the agent session. In yet another example, a pre-determined schedule may determine which combination of inputs to request as part of the agent session. The combination of inputs used by the subsequent agent session 142 to generate the output signal OUTPUT may be varied according to the design criteria of a particular implementation.

The signal IMS may enable the independent memory store 150 to be referenceable by the subsequent agent sessions 142 in order to influence agent behavior. The output of the memory consolidation system 102 may operate at the inference pipeline layer 114 of the environment of the memory consolidation architecture 140 (e.g., the language-model agent environment). The independent memory store 150 may enable adjusting at least one of contextual embeddings, token-bias parameters, stability coefficients, prompt-graph configuration, temperature, context-window weighting, prompt-template parameters, etc. The independent memory store 150 may enable the influence of the subsequent agent session 142 with no modification of underlying language-model weights (e.g., the trained model 122). The independent memory store 150 may be the input for the subsequent agent session 142 that does not affect a weight of the AI engine 80 used to generate output for the subsequent agent session 142. For example, when referenced by the subsequent agent session 142, the independent memory store 150 may affect artifact retrieval, be applied to the current session context, govern current-session behavior, influence current-session behavior, etc. The independent memory store 150 may enable cross-system propagation (e.g., via external system interfaces, format conversions, propagation governance, etc.). The memory consolidation system 102 may generate new and/or reorganized memory store (e.g., the independent memory store 150) that may exist alongside the persistent memory store 152 and/or the accumulated session data 144. The new and/or reorganized memory store may merge duplicate content, replace stale and/or contradicted entries and/or surface new insights. Details of the independent memory store 150 may be described in association with U.S. Provisional Application No. 63/911,540, filed on Nov. 5, 2025, titled “Signal Integrity as Trust Memory System” in particular at claim 8, U.S. Provisional Application No. 63/912,463, filed on Nov. 6, 2025, titled “Cognitive Compression Prioritization and Fusion Memory System” in particular at claims 13(c) and 13(e), “Guided Cognitive Drift System with Cross-Thread Re-Anchoring” in particular at claims 1(f) and 4, and “Public Collaborative Trait-Exchange and Collective Resonance Mapping System” in particular at claim 1(b), and/or U.S. Provisional Application No. 63/914,590, filed on Nov. 10, 2025, titled “Adaptive Prompt-System Control Architecture” in particular at claims 1(a), 2, and 6, and “Curated Cognitive Profile Portability System” in particular at claims 1(c) and 1(d), appropriate portions of which are incorporated by reference.

The memory consolidation architecture 140 may preserve the accumulated session data 144 in an unmodified state during and after operation of the curation module 174. The curation module 174 may operate on a representation of the session data (e.g., extracted patterns, computed statistics, derived structured artifacts, etc. generated by the pattern extraction module 172) rather than directly on the accumulated session data 144. Where the independent memory store 150 replaces and/or summarizes portions of the persistent memory store 152, the original content may be preserved through one or more preservation mechanisms (e.g., separate storage with provenance-token cross-references, audit-reconstruction interfaces that may regenerate original content on demand using stored compression factors and semantic-context identifiers, thread isolation with thread-validated access identifiers that may prevent inadvertent modification of source data, storage durability and/or retention policies, selective access controls for original session data, etc.). The preservation commitment may enable auditability, selective reversibility, regulatory compliance, and/or debugging. For example, the independent memory store 150 that may produce an undesirable agent behavior may be identified and removed, and the behavior of the agent may return to the prior state without loss of the underlying session data that originally informed the update. Details of preservation of the accumulated session data 144 may be described in association with U.S. Provisional Application No. 63/912,463, filed on Nov. 6, 2025, titled “Cognitive Compression Prioritization and Fusion Memory System”, “Collaborative Trait Ingest Filter (CTIF)”, “Guided Cognitive Drift System with Cross-Thread Re-Anchoring” and “Narrative-Derived Character Modeling System with Thread Isolation”, appropriate portions of which are incorporated by reference.

The memory consolidation architecture 140 of the memory consolidation system 102 may comprise a number of core modules. Data may flow from the persistent memory store 152 and the accumulated session data 144 through the scheduled processing module 170 to the pattern extraction module 172, to the curation module 174, the review-gate controller 176, and/or the governance interface 178. Each of the scheduled processing module 170, the pattern extraction module 172, the curation module 174, the review-gate controller 176 and/or the governance interface 178 may be implemented in response to instructions stored by a non-transitory computer-readable medium and executed by one or more processors (e.g., hardware implemented by the user devices 52a-52n and/or server computers 70a-70n). The memory consolidation architecture 140 may enable inter-module interfaces and message formats. The memory consolidation architecture 140 may have deployment topology options that may comprise single-host, distributed multi-host, hierarchical multi-tier configurations, etc. The agent session 142 may receive fragments of prior context assembled into a prompt and produce output influenced by those fragments along with everything available in the context window. The influence provided by the independent memory store 150 does not necessarily govern the output of the subsequent agent session 142. For example, the independent memory store 150 may compete for attention with the rest of the prompt to the subsequent agent session 142. Details of the memory consolidation architecture 140 may be described in association with U.S. Provisional Application No. 63/912,463, filed on Nov. 6, 2025, titled “Contrastive Memory-Resonance System for Character-Aware Context” and/or U.S. Provisional Application No. 63/914,590, filed on Nov. 10, 2025, titled “Adaptive Herd-Coherence Engine”, appropriate portions of which are incorporated by reference.

### Extensions Beyond Memory Replay

Many memory-consolidation architectures focus primarily on preserving, organizing, and reintroducing previously existing information. In certain embodiments described herein, information derived from prior interactions may instead be transformed into newly generated content that was not explicitly present within the original conversational history. Such content may be generated from analysis of prior interactions and utilized to influence subsequent conversational behavior.

Referring to FIG. 4, a block diagram illustrating forward binding substitution is shown. A forward binding architecture 200 for the memory consolidation system 102′ is shown. The forward binding architecture 200 may be an optional embodiment for the memory consolidation system 102′. The forward binding memory consolidation system 102′ may be configured to convert curated update content from a probabilistic prompt-assembly influence into structural governance for an agent output. The forward binding memory consolidation system 102′ may provide a combination of memory consolidation with structural token positioning that may enable authoritative behavioral governance rather than influence competition for attention with the rest of the context window. The forward binding architecture 200 may comprise the transformer models 80a-80n and the forward binding memory consolidation system 102′.

The forward binding memory consolidation system 102′ may comprise a block (or circuit) 202, a block (or circuit) 204, a combination of blocks (or operations) 206, a block (or circuit) 208, and/or a combination of blocks (or operations) 210. The circuit 202 may implement a forward-binding analysis module. The block 204 may represent a synthesized corrective content module. The combination of operations 206 may implement tokenization operations. The circuit 208 may implement a token sequencer. The combination of operations 210 may implement embedding/encoding operations. The forward binding memory consolidation system 102′ may comprise other components (not shown). The number, type and/or arrangement of the components of the forward binding memory consolidation system 102′ may be varied according to the design criteria of a particular implementation.

The forward binding memory consolidation system 102′ may receive a signal (e.g., PR-FL), a signal (e.g., INPUT) and/or the signal SOURCE. The forward binding memory consolidation system 102′ may generate a signal (e.g., AWT). In the example shown, for simplicity, the signal INPUT and/or the signal SOURCE may be illustrated internal to the forward binding memory consolidation system 102′. However, the signal INPUT and/or the signal SOURCE may be a signal received from an external source. For example, the signal INPUT may be an input signal received from one of the user devices 52a-52n (e.g., the signal REQUEST described in association with FIG. 1) and the signal SOURCE may be received from the authoritative data source 54. The signal PR-FL may be an output of the transformer models 80a-80n. The signal PR-FL may comprise probabilistic output generated by the transformer models 80a-80n. The signal PR-FL may further comprise positional information generated by the forward binding memory consolidation system 102′. In an example, the signal PR-FL may comprise the probabilistically inferred content generated by the AI engine 80 in addition to positional information (e.g., positional flags, a placeholder marker, a reserved token, a low-confidence token, etc.) generated based on the positional information provided in the signal AWT. The positional information may enable the governance layer 100 to reconstruct and/or assemble forward-bound content in the context of the probabilistically inferred content of the signal PR-FL. The signal PR-FL may be presented as feedback to the forward binding memory consolidation system 102′. In some embodiments, the signal PR-FL may be presented to the downstream process 56 (e.g., or an authoritatively bound governed version of the output from an assembly module may be output to the downstream process 56). The signal AWT may comprise a conditioned version of the forward-bound content and/or a conditioned version of the input request from the signal INPUT. In one example, the signal AWT may comprise a positional precedence and/or overweight values for the forward-bound content. In an example, the token sequencer 208 may be configured to establish positional precedence for the forward-bound content. Details of the signal PR-FL and/or the signal AWT may be described in association with U.S. patent application Ser. No. 19/662,132, filed on Apr. 29, 2026, appropriate portions of which are incorporated by reference. The forward binding memory consolidation system 102′ may generate and/or receive other signals (not shown). The content, format and/or type of data communicated to/from the forward binding memory consolidation system 102′ may be varied according to the design criteria of a particular implementation.

The forward-binding analysis module 202 may comprise a block (or circuit) 220, a block (or circuit) 222 and/or a block (or circuit) 224). The circuit 220 may implement a source analyzer. The circuit 222 may implement a governance state module. The circuit 224 may implement a pedigree analysis module. The forward-binding analysis module 202 may comprise other components (not shown). The number, type and/or arrangement of the components of the forward-binding analysis module 202 may be varied according to the design criteria of a particular implementation.

The source analyzer 220 may be configured to perform an analysis of source data for the forward-binding analysis module 202. The source analyzer 220 may receive the signal PR-FL. The source analyzer 220 may be configured to generate the signal IMS in response to the signal PR-FL. In one example, the source analyzer 220 may comprise one or more of the scheduled processing module 170, the pattern extraction module 172, the curation module 174, the review-gate controller 176, and/or the governance interface 178 described in association with FIG. 3, in order to generate the signal IMS. For example, the forward binding memory consolidation system 102′ may receive user content from an end user during a conversational turn between the end user (e.g., using the user devices 52a-52n) and the transformer models 80a-80n (e.g., the user may provide the signal INPUT). In some embodiments, the governance layer 100 and/or the transformer models 80a-80n may receive the signal SOURCE from the authoritative data source 54 in order to provide authoritatively bound data for the response to the user request. For the conversational turn, the transformer models 80a-80n may generate the signal PR-FL (e.g., generative output). In one example, when starting a conversation, the user may provide first user content and the transformer models 80a-80n may generate first generative output. After the first conversational turn, the end user may continue with additional (e.g., subsequent) conversational turns. The source analyzer 220 may generate the signal IMS in response to an analysis of the generative output in the signal PR-FL. For example, for the first conversational turn, there may be no prior generative output to operate on, but after the first conversational turn has ended, the source analyzer 220 may use the first generative output for analysis that may be used for subsequent conversational turns. The signal IMS may be presented to the governance state module 222 and/or the pedigree analysis module 224.

The governance state module 222 may receive the signal IMS. The governance state module 222 may be configured to generate a token priority order in response to the analysis of the generative output provided by the source analyzer 220 after a conversational turn has ended. The governance state module 222 may generate the token priority order in response to detecting one or more of hallucination indicators, authority conflicts, source-selection failures, recurring user corrections, coherence degradation, abandonment of conversations, contradictory outputs, workflow failures, repeated task retries, unsuccessful agent actions, etc. The token priority order may provide information about the previous conversational turns that may be used to prioritize the content from the independent memory store 150 for use in subsequent conversational turns. The governance state module 222 may generate the signal ORDER. The signal ORDER may comprise the prioritization data derived from the independent memory store 150. The signal ORDER may be presented to the token sequencer 208.

The pedigree analysis module 224 may be configured to receive the signal IMS. The pedigree analysis module 224 may be configured to generate a diagnostic state in response to an analysis of the generative output provided by the source analyzer 220. The pedigree analysis module 224 may be configured to generate weighting values that may represent the diagnostic state for synthesized governance content. The synthesized governance content may comprise a source of authoritative content for use in the subsequent conversational turns. The pedigree analysis module 224 may analyze the content from the independent memory store 150 and/or the metadata associated with the content of the independent memory store 150 to ensure that the data is reliable. For example, the pedigree analysis module 224 may analyze a pedigree of the content in the independent memory store 150 (e.g., to ensure that the data is reliable based on the source form which the content was derived). The pedigree analysis module 224 may generate one or more signals (e.g., A-WB_A-A-WB_I). The signals A-WB_A-A-WB_I may comprise weighting data for the various content in the independent memory store 150. For example, the weighting data may indicate which of the content from the independent memory store 150 may be more reliable and/or of greater relevance. The signals A-WB_A-A-WB_I may be presented to the synthesized corrective content module 204.

### Synthetic Governance Generation

In some embodiments, memory consolidation may result in selection and reuse of previously existing content. In other embodiments, analysis of prior interactions may generate new governance content, corrective content, synthesized prompts, inferred instructions, or other machine-generated information. Such generated content may be utilized during subsequent inference operations even when the generated content did not explicitly appear in the prior conversational history.

The synthesized corrective content module 204 may be configured to receive the signals A-WT_A-A-WT_I and/or the signal PR-FL. The synthesized corrective content module 204 may be configured to generate the synthesized governance content in response to the diagnostic state provided in the signals A-WT_A-A-WT_I. The synthesized governance content may be constructed based on a prior conversation history between the end user and the transformer models 80a-80n, but is not content explicitly present in the prior conversation history. For example, the synthesized governance content generated by the synthesized corrective content module 204 is not the input provided from one of the user devices 52a-52n. In one example, for Anthropic's Claude “Dreaming”, announced on May 6, 2026, the prior conversation history may be selected and/or re-used. For the forward binding memory consolidation system 102′, the synthesized governance content may be new governance content. The synthesized corrective content module 204 may consolidate and/or apply the pedigree weights A-WT_A-A-WT_I to the probabilistically inferred output in the signal PR-FL of the transformer models 80a-80n to generate the synthesized governance content. For example, the synthesized governance content generated by the synthesized corrective content module 204 is not required to be previously present in the first generative output and/or the first user input content.

The synthesized corrective content module 204 may be configured to generate a signal (e.g., SOURCE′). The signal SOURCE′ may comprise the synthesized governance content. The signal SOURCE′ may be presented as an input for the tokenization operations 206. The signal SOURCE′ may be used as an authoritative input for the tokenization operations 206 (e.g., in addition to and/or in place of the signal SOURCE from the authoritative data source 54). The synthesized governance content may comprise one or more of synthetic prompts, synthetic examples, synthetic counterexamples, workflow instructions, inferred authority ranking adjustments, inferred source selection guidance, confidence modifiers, inferred behavioral constraints, inferred corrective guidance, inferred user preferences, inferred governance instructions, etc. For example, the synthesized corrective content module 204 may implement a synthetic governance construction mechanism. Details of the source analyzer 220, the governance state module 222, the pedigree analysis module 224 and/or the synthesized corrective content module 204 may be described in association with U.S. Provisional Application No. 64/062,752, filed on May 11, 2026, and U.S. Provisional Application No. 64/070,260, filed on May 20, 2026, appropriate portions of which are incorporated by reference.

The tokenization operations 206 may be configured to receive the signal INPUT, the signal SOURCE and/or the signal SOURCE′. The tokenization operations 206 may be configured to tokenize various input sources into a format that may be operated on by the token sequencer 208 and/or the transformer models 80a-80n. The tokenization operations 206 may tokenize the synthesized governance content through an independent governance tokenization path distinct from a tokenization path used for the plurality of conversational turns to provide tokenized synthesized governance content. The tokenization operations 206 may generate a signal (e.g., TSRC) and/or a signal (e.g., NCTKN). The signal TSRC may comprise the tokenized synthetic governance content. The signal NCTKN may comprise a tokenized version of non-curated input content (e.g., generated in response to the signal INPUT and/or the signal SOURCE). For example, the signal TSRC may be generated by one path of the tokenization operations 206 and the signal NCTKN may be generated by a separate, distinct path of the tokenization operations 206. In an example, the content for the independent memory store 150 may be transmitted to a tokenization layer of the language-model agent environment (e.g., the tokenization operations 206 and the token sequencer 208), which may position tokens derived from the independent memory store 150 at designated token positions in a token sequence consumed by an inference operation. The signal TSRC and the signal NCTKN may be presented to the token sequencer 208. In some embodiments, the signal NCTKN may be presented to the embedding/encoding operations 210 directly (e.g., bypassing the token sequencer 208, for example, on a first conversational turn and/or other operations that do not necessarily benefit from token sequencing to conserve resources). Details of the tokenization and/or the distinct path for tokenization may be described in association with U.S. patent application Ser. No. 19/662,132, filed on Apr. 29, 2026, appropriate portions of which are incorporated by reference.

### Influence Through Structured Context Placement

Once generated, synthesized content may be introduced into future inference operations using a variety of mechanisms. In certain embodiments, tokenization, sequencing, positioning, weighting, or ordering operations may be utilized to place such content within selected portions of an input sequence prior to execution of a transformer-based inference process.

The token sequencer 208 may receive the signal TSRC, the signal NCTKN and/or the signal ORDER. The token sequencer 208 may receive subsequent user content during one or more of the subsequent conversational turns (e.g., the signal NCTKN derived from the signal INPUT and/or the signal SOURCE). The token sequencer 208 may receive the synthesized generative content (e.g. the signal TSRC comprising the synthesized governance content derived from the independent memory store 150 as the signal SOURCE′). The token sequencer 208 may be configured to merge the tokenized synthesized governance content with the subsequent user content tokenized to produce a merged input sequence before execution of a bounded transformer operation corresponding to one of the subsequent conversational turns. The token sequencer 208 may generate a signal (e.g., PRTS). The signal PRTS may comprise the merged input sequence. The signal PRTS may comprise synthesized governance content constructed in response to diagnostic state independent from subsequent conversational turns (e.g., data from the signal TSRC) and the data from the subsequent conversational turn (e.g., data from the signal NCTKN). The token sequencer 208 may be configured to prioritize tokens based on the signal ORDER. The token sequencer 208 may be configured to position the tokenized synthesized governance content at designated token positions in a token sequence consumed by an inference operation of the transformer (e.g., positions that may prioritize the synthesized governance content). The signal ORDER may provide prioritization information received from the governance state module 222.

The designated token positions may comprise high-ranking token positions within an attention mechanism of the inference operation, such that tokens derived from the independent memory store 150 may exert higher attention weight on the inference operation (e.g., based on the signals A-WT_A-A-WT_I and the signal ORDER) than tokens introduced through conventional prompt assembly (e.g., based on the signal INPUT and/or the signal SOURCE). The tokenization operations 206 may comprise a dual-vocabulary tokenization path with a first path for tokens derived from the independent memory store 150 and a second path for tokens derived from the non-curated input and the token sequencer 208 may apply structural positioning rules distinct between the paths. Tokens derived from the independent memory store 150 may be positioned by the token sequencer 208 within the token sequence prior to embedding by the inference operation. Positioning the tokens prior to the embedding/encoding operations 210 may provide positioning that may be fixed at the input layer rather than determined probabilistically during inference. In some embodiments, an assembly module may substitute tokens derived from the independent memory store 150 for corresponding tokens in the token sequence based on a match between an authoritative-source identifier of the independent memory store 150 and a placeholder token in the sequence. Details of the token sequencing and/or the assembly module may be described in association with U.S. patent application Ser. No. 19/662,132, filed on Apr. 29, 2026, appropriate portions of which are incorporated by reference.

The token sequencer 208 may provide a portion of the tokenization layer architecture. High-ranking attention position placement may be implemented by the token sequencer 208 such as position-selection techniques and/or attention-weight outcomes. The dual-vocabulary tokenization paths provided by the tokenization operations 206 may enable vocabulary construction, path selection logic, structural positioning rule differences. etc. Pre-embedding positioning by the token sequencer 208 may enable input-layer placement mechanisms. The assembly module may implement substitution rules, authoritative-source identifier matching, placeholder token handling. The attention-weight monitoring of the token sequencer 208 may implement a measurement technique, feedback to the curation module 174, adaptive adjustment of subsequent artifact generation, etc. Details of the token sequencer 208, the assembly module and/or the tokenzation layer may be described in association with U.S. Provisional Application No. 63/914,590, filed on Nov. 10, 2025, titled “Adaptive Prompt-System Control Architecture” and/or U.S. patent application Ser. No. 19/662,132, filed on Apr. 29, 2026, appropriate portions of which are incorporated by reference.

### Continuing Evolution of Memory Consolidation Architectures

The examples presented herein demonstrate that memory-consolidation systems may evolve from storage and retrieval mechanisms into increasingly sophisticated architectures capable of generating derived guidance, synthesized context, behavioral constraints, and other forms of machine-generated control information. The disclosed embodiments encompass both current and future implementations of such architectures.

The embedding/encoding operations 210 may receive the signal PRTS. The embedding/encoding operations 210 may be configured to supply the merged input sequence as an input embedding to transformer models 80a-80n for generation of a subsequent transformer response. The governance, guidance and/or influence provided by the forward binding memory consolidation system 102′ may be provided without modification of the transformer models 80a-80n. The embedding/encoding operations 210 may generate the signal AWT. The signal AWT may provide a synthetic prompt (e.g., a prompt comprising input that may comprise tokenized words that were not specifically input by the end user). The signal AWT may govern the inference operations of the transformer models 80a-80n across conversational turns.

The transformer models 80a-80n may generate the signal PR-FL in response to the signal AWT. The signal PR-FL may comprise the probabilistically inferred content generated by the transformer models 80a-80n. In some embodiments, such as the first conversational turn when there is no prior conversational history and/or when the forward binding memory consolidation system 102′ is disabled, the signal PR-FL may be generated in response to the signal INPUT and/or the signal SOURCE. In some embodiments, the signal PR-FL may comprise the probabilistically inferred content with the positional information provided by the token sequencer 208. In some embodiments, the signal PR-FL may be presented as the output to the end user. For example, if output governance and/or forward binding performed by the forward binding memory consolidation system 102′ is disabled, then the signal PR-FL may be the output presented to the end user. If the output governance performed by the governance layer 100 and/or the forward binding performed by the forward binding memory consolidation system 102′ is enabled, then the signal PR-FL may be fed back to the forward binding memory consolidation system 102′ and/or provided to an assembly module. The assembly module may assemble the output with the forward-bound content and/or the authoritative content and present the governed output (e.g., the signal GOV) to the end user. Details of the assembly module may be described association with U.S. patent application Ser. No. 19/662,132, filed on Apr. 29, 2026, appropriate portions of which are incorporated by reference.

The forward binding memory consolidation system 102′ may be configured to perform bounded semantic property annotation. The bounded semantic property annotations may comprise property taxonomy, annotation techniques, a scope of bounded exposure, etc. The forward binding memory consolidation system 102′ may enable opaque-handle substitution, which may handle data structure, provide a substitution mechanism in a token sequence, enable an inference-operation interface with a handle. The forward binding memory consolidation system 102′ may enable inference operation reasoning over bounded properties by permitted operations, prohibited operations, derivational drift prevention, etc. The forward binding memory consolidation system 102′ may be different from a conventional context-window assembly and/or from a RAG. Details of the forward binding memory consolidation system 102′ may be described in association with U.S. Provisional Application No. 64/049,578, filed on Apr. 25, 2026, and/or U.S. patent application Ser. No. 19/662,132, filed on Apr. 29, 2026, appropriate portions of which are incorporated by reference.

The memory consolidation system 102 may be configured to provide authoritative-source content identification and/or tagging. The authoritative-source content may be provided by the authoritative data source 54. The authoritative-source binding may provide rules for mandatory authoritative grounding to source content. The authoritative-source binding may implement a tokenization layer prohibition mechanism, which may be enforced at the inference-input layer. The tokenization operations 206 and/or the token sequencer 208 may provide fallback to inference when no authoritative source exists for a required value (e.g., the signal NCTKN may be provided to the embedding/encoding operations 210 without the token sequencer 208 when authoritative source is absent). The authoritative content binding may provide architectural prohibition from using probabilistic content for authoritatively bound roles (e.g., compared to RAG architectures, which may implement probabilistic retrieval-and-prompt). Details of the authoritative source binding may be described in association with U.S. patent application Ser. No. 19/639,076, filed on Apr. 3, 2026, and/or U.S. patent application Ser. No. 19/662,132, filed on Apr. 29, 2026, appropriate portions of which are incorporated by reference.

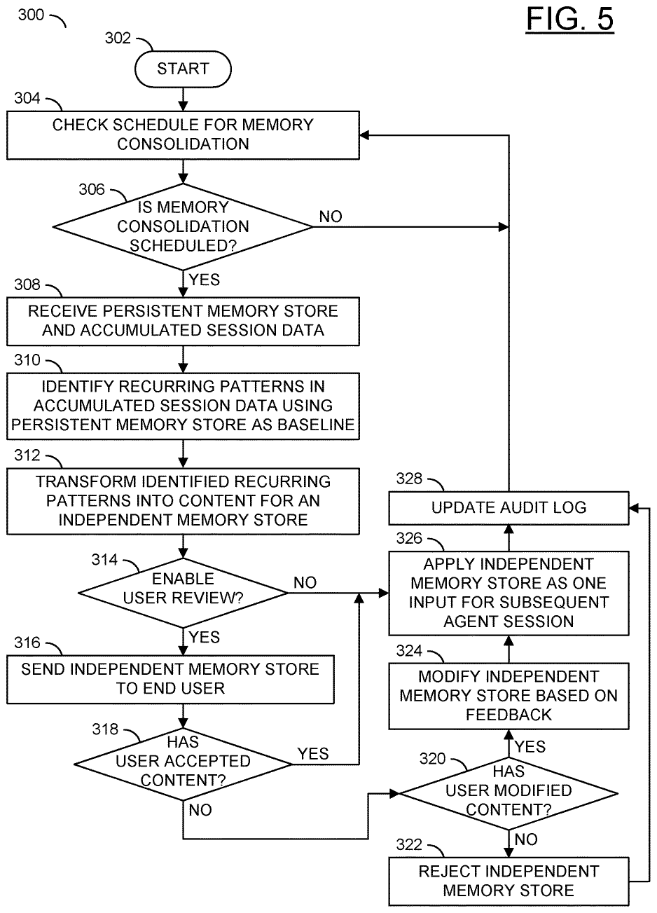

Referring to FIG. 5, a method (or process) 300 is shown. The method 300 may implement memory consolidation for a language-model agent environment. The method 300 generally comprises a step (or state) 302, a step (or state) 304, a decision step (or state) 306, a step (or state) 308, a step (or state) 310, a step (or state) 312, a decision step (or state) 314, a step (or state) 316, a decision step (or state) 318, a decision step (or state) 320, a step (or state) 322, a step (or state) 324, a step (or state) 326, and a step (or state) 328.

The step 302 may start the method 300. In the step 304, the scheduled processing module 170 may check a schedule for memory consolidation. In an example, the memory consolidation operations may be performed as a background process in between agent sessions. In another example, the memory consolidation operations may be performed when the agent(s) are not actively working. Details of the scheduling may be described in association with U.S. Provisional Application No. 63/912,463, filed on Nov. 6, 2025, titled “Guided Cognitive Drift System with Cross-Thread Re-Anchoring” in particular at claim 1(e), and/or U.S. Provisional Application No. 63/914,590, filed on Nov. 10, 2025, titled “Adaptive Prompt-System Control Architecture” in particular at claim 8, appropriate portions of which are incorporated by reference. Next, in the decision step 306, the scheduled processing module 170 may determine whether memory consolidation is currently scheduled. If the memory consolidation is not scheduled, then the method 300 may return to the step 304. If the memory consolidation is scheduled, then the method 300 may move to the step 308.

In the step 308, the scheduled processing module 170 may receive the persistent memory store 152 and the accumulated session data 144. For example, the scheduled processing module 170 may receive the signal DATA and the signal ACC and provide the signal AC-DATA to the pattern extraction module 172. Next, in the step 310, the pattern extraction module 172 may identify the recurring patterns in the accumulated session data 144 using the persistent memory store 152 as a baseline. For example, the pattern extraction module 172 may present the signal RPAT to the curation module 174. In the step 312, the curation module 174 may transform the identified recurring patterns into content for the independent memory store 150. For example, the curation module 174 may generate the signal CON and present the signal CON to the review-gate controller 176 and/or the governance interface 178. Next, the method 300 may move to the decision step 314.

In the decision step 314, the review-gate controller 176 may determine a current mode of operation. In an example, the mode of operation may be a user selection and/or an initial condition. If the current mode of operation is an automatic mode of operation, then the method 300 may move to the step 326. If the current mode of operation is a review mode of operation then the method 300 may move to the step 316. In the step 316, the review-gate controller 176 may send the independent memory store 150 for review to the user interface 180. In an example, the review-gate controller 176 may provide the signal IMS to the user interface 180. Next, the method 300 may move to the decision step 318.

In the decision step 318, the review-gate controller 176 may determine whether the user has accepted the content of the independent memory store 150. For example, the review-gate controller 176 may receive the signal USR comprising user feedback from the user interface 180. If the user has accepted the content, then the method 300 may move to the step 326. If the user has not accepted the content, then the method 300 may move to the decision step 320. In the decision step 320, the review-gate controller 176 may determine whether the user has modified the content for the independent memory store 150. For example, the signal USR may comprise modifications as feedback. If the user has not modified the feedback, then the method 300 may move to the step 322. In the step 322, the user may have rejected the content for the independent memory store 150 in the signal USR. The independent memory store 150 is not applied to the user memory 130 and the method 300 may move to the step 328. In the decision step 320, if the user has modified the content, then the method 300 may move to the step 324. In the step 324, the review-gate controller 176 may modify the independent memory store 150 based on the feedback in the signal USR. Next, in the step 326, the review-gate controller 176 may apply the independent memory store 150 to the user memory 130. For example, the independent memory store 150 may be available as one input for a subsequent agent session. Next, the method 300 may move to the step 328. In the step 328, the governance interface 178 may update the audit log. For example, the audit log may comprise the content for the independent memory store 150, the decision by the end user and/or operations performed by the review-gate controller 176. The audit log may be provided as feedback to the curation module 174. Next, the method 300 may return to the step 304.

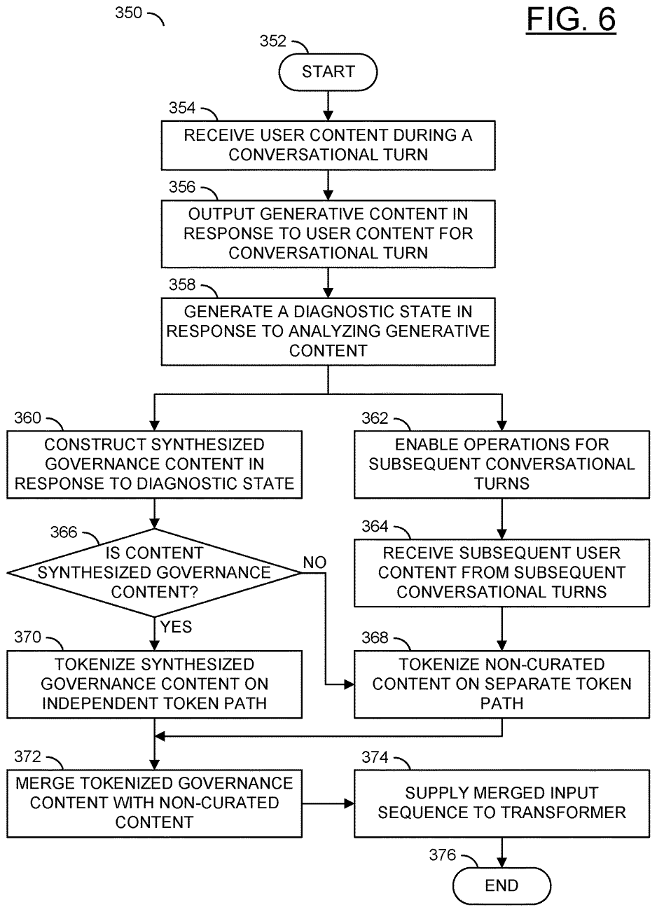

Referring to FIG. 6, a method (or process) 350 is shown. The method 350 may implement memory consolidation with forward binding. The method 350 generally comprises a step (or state) 352, a step (or state) 354, a step (or state) 356, a step (or state) 358, a step (or state) 360, a step (or state) 362, a step (or state) 364, a decision step (or state) 366, a step (or state) 368, a step (or state) 370, a step (or state) 372, a step (or state) 374, and a step (or state) 376.

The step 352 may start the method 350. In the step 354, the transformer models 80a-80n may receive user content during a conversational turn. Next, in the step 356 the transformer models 80a-80n may output generative content in response to the user content for the same conversational turn. For example, the transformer models 80a-80n may generate the signal PR-FL in response to the signal INPUT and/or the signal SOURCE. In the step 358, the pedigree analysis module 224 may generate a diagnostic state in response to analyzing the generative content. For example, the source analyzer 220 may receive the signal PR-FL and generate the signal IMS (e.g., the independent memory store 150) and the pedigree analysis module 224 may analyze the independent memory store 150. Next, the method 350 may move to the step 360 and/or the step 362.

In the step 360, the synthesized corrective content module 204 may construct the synthesized governance content in response to the diagnostic state. For example, the signals A-WT_A-A-WT_I may be presented by the pedigree analysis module 224 to the synthesized corrective content module 204 and the synthesized corrective content module 204 may generate the synthesized corrective content (e.g., the signal SOURCE′) from the independent memory store 150. Next, the method 350 may move to the decision step 366. In parallel (or substantially in parallel), in the step 362, the forward binding memory consolidation system 102′ may enable operations for subsequent conversational turns. In the step 364, the forward binding memory consolidation system 102′ may receive subsequent user content from subsequent conversational turns. For example, a subsequent signal INPUT may be received and/or the signal SOURCE for a next conversational turn. Next, the method 350 may move to the step 368.

In the decision step 366, the tokenization operations 206 may determine whether the content received is the synthesized corrective content. If the content is not the synthesized corrective content (e.g., non-curated content), then the method 350 may move to the step 368. In the step 368, the tokenization operations 206 may tokenize the non-curated content on a separate token path from a token path used for the synthesized corrective content. For example, the non-curated content may be tokenized and communicated as the signal NCTKN. Next, the method 350 may move to the step 372. In the decision step 366 if the content is the synthesized corrective content, then the method 350 may move to the step 370. In the step 370, the tokenization operations 206 may tokenize the synthesized corrective content on an independent token path. For example, the synthesized corrective content may be tokenized and communicated as the signal TSRC. Next, the method 350 may move to the step 372.

In the step 372, the token sequencer 208 may merge the synthesized corrective content with the non-curated content. For example, the token sequencer 208 may positionally prioritize the synthesized corrective content in a token sequence according to the signal ORDER. Next, in the step 374, the embedding/encoding operations 210 may supply the merged input sequence to the transformer models 80a-80n. For example, the token sequencer 208 may generate the signal PRTS comprising the prioritized token sequence and the embedding/encoding operations 210 may embed the token sequence into the signal AWT. Next, the method 350 may move to the step 376. The step 376 may end the method 350.

The functions performed by the diagrams of FIGS. 1-6 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the specification, as will be apparent to those skilled in the relevant art(s). Appropriate software, firmware, coding, routines, instructions, opcodes, microcode, and/or program modules may readily be prepared by skilled programmers based on the teachings of the disclosure, as will also be apparent to those skilled in the relevant art(s). The software is generally executed from a medium or several media by one or more of the processors of the machine implementation.

The invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The invention thus may also include a computer product which may be a storage medium or media and/or a transmission medium or media including instructions which may be used to program a machine to perform one or more processes or methods in accordance with the invention. Execution of instructions contained in the computer product by the machine, along with operations of surrounding circuitry, may transform input data into one or more files on the storage medium and/or one or more output signals representative of a physical object or substance, such as an audio and/or visual depiction. Execution of instructions contained in the computer product by the machine, may be executed on data stored on a storage medium and/or user input and/or in combination with a value generated using a random number generator implemented by the computer product. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (erasable programmable ROMs), EEPROMs (electrically erasable programmable ROMs), UVPROMs (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, cloud servers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

The designations of various components, modules and/or circuits as “a” “n”, when used herein, disclose either a singular component, module and/or circuit or a plurality of such components, modules and/or circuits, with the “n” designation applied to mean any particular integer number. Different components, modules and/or circuits that each have instances (or occurrences) with designations of “a” “n” may indicate that the different components, modules and/or circuits may have a matching number of instances or a different number of instances. The instance designated “a” may represent a first of a plurality of instances and the instance “n” may refer to a last of a plurality of instances, while not implying a particular number of instances.

While the invention has been particularly shown and described with reference to embodiments thereof, it will be understood by those skilled in the art that various changes in form and details may be made without departing from the scope of the invention.

1. A computer-implemented system for memory consolidation in a language-model agent environment, comprising:
a scheduled processing module configured to operate on (i) a persistent memory store and (ii) accumulated session data from one or more prior agent sessions;
a pattern-extraction module configured to identify recurring patterns across said accumulated session data based on said persistent memory store;
a curation module configured to transform said identified recurring patterns into content for an independent memory store; and
a review-gate controller configured to generate said independent memory store according to one of (i) an automatic mode of operation and (ii) a review mode of operation, wherein
(a) said automatic mode of operation is configured to apply said independent memory store without an intervening action from a user,
(b) said review mode of operation is configured to present said independent memory store to said user to enable said user to provide feedback for said content in said independent memory store prior to applying said independent memory store, and
(c) said independent memory store is applied as one source for an input to influence behavior of subsequent agent sessions according to said review-gate controller.

2. The computer-implemented system according to claim 1, wherein said recurring patterns span a plurality of agents.

3. The computer-implemented system according to claim 1, wherein said scheduled processing module is configured to operate between agent sessions.

4. The computer-implemented system according to claim 1, further comprising a governance interface configured to record said independent memory store, application events of said independent memory store, and operations of said review-gate controller in an auditable record.

5. The computer-implemented system according to claim 4, wherein (i) said auditable record is provided as feedback to said curation module and (ii) said curation module is further configured to generate said content for said independent memory store in response to said auditable record.

6. The computer-implemented system according to claim 1, wherein (i) said computer-implemented system is configured to operate at an inference-pipeline layer of said language-model agent environment, and (ii) said independent memory store is said input for said subsequent agent sessions that does not affect a weight of a transformer model used to generate output for said subsequent agent sessions.

7. The computer-implemented system according to claim 1, wherein said independent memory store is applied as said input instead of said persistent memory store.

8. The computer-implemented system according to claim 1, wherein said independent memory store is applied as said input in addition to said persistent memory store.

9. The computer-implemented system according to claim 1, wherein said pattern-extraction module is configured to use said persistent memory store as a baseline for identifying said recurring patterns across said accumulated session data.

10. The computer-implemented system according to claim 1, wherein said persistent memory store comprises content from one or more consolidation operations based on said prior agent sessions.

11. The computer-implemented system according to claim 1, wherein said feedback provided by said user comprises selecting whether to accept, reject, or modify said content of said independent memory store.

12. The computer-implemented system according to claim 1, wherein said accumulated session data comprises past session transcripts of conversational turns between said user and output from a transformer model.

13. The computer-implemented system according to claim 1, wherein said content for said independent memory store is generated in response to transforming said identified recurring patterns into one or more of playbooks, notes and other curated output for said independent memory store.

14. The computer-implemented system according to claim 1, wherein said independent memory store provides an adjustment to at least one of contextual embeddings, token-bias parameters, stability coefficients, prompt-graph configuration, temperature, context-window weighting, and prompt-template parameters.

15. The computer-implemented system according to claim 1, wherein said curation module is configured to merge said content with said persistent memory store by a comparison of said content against existing entries in said persistent memory store, identifying redundant entries in response to said comparison, and consolidating said redundant entries while preserving non-redundant content.

16. The computer-implemented system according to claim 1, wherein said scheduled processing module is triggered in response to at least one of a temporal schedule, a session-count threshold, a memory-store size threshold, and an external command.

17. The computer-implemented system according to claim 1, wherein each of said scheduled processing module, said pattern-extraction module, said curation module and said review-gate controller are implemented in response to instructions stored by a non-transitory computer-readable medium and executed by one or more processors.

18. A computer-implemented method for governing transformer inference across conversational turns, the method comprising:
receiving first user content from an end user during a first conversational turn of a plurality of conversational turns between said end user and a transformer;
generating a first generative output using said transformer in response to said first user content during said first conversational turn;
generating a diagnostic state in response to an analysis of said first generative output after said first conversational turn has ended;
constructing synthesized governance content in response to said diagnostic state independent from subsequent conversational turns of said plurality of conversational turns;
tokenizing said synthesized governance content through an independent governance tokenization path distinct from a tokenization path used for said plurality of conversational turns to provide tokenized synthesized governance content;
receiving subsequent user content during one or more of said subsequent conversational turns;
merging said tokenized synthesized governance content with said subsequent user content tokenized using said tokenization path to produce a merged input sequence before execution of a bounded transformer operation corresponding to one of said subsequent conversational turns; and
supplying said merged input sequence as an input embedding to said transformer for generation of a subsequent transformer response without modification of said transformer.

19. The computer-implemented method according to claim 18, wherein said synthesized governance content is constructed based on a prior conversation history and is not explicitly present in said prior conversation history.

20. The computer-implemented method according to claim 18, wherein said tokenizing is configured to position said tokenized synthesized governance content at designated token positions in a token sequence consumed by an inference operation of said transformer.
